(19) United States
(12) Patent Application Publication
(10) Pub. No.: US 2023/0002226 A1
(43) Pub. Date: Jan. 5, 2023

(54) HYDROGEN STORAGE MATERIALS AND PROCESSES FOR PREPARING SAME

(71) Applicant: Kubagen Limited, Cardiff (GB)

(72) Inventor: David ANTONELLI, Cardiff (GB)

(21) Appl. No.: 17/760,776

(22) PCT Filed: Sep. 16, 2020
(86) PCT No.: PCT/IB2020/058638

§ 371 Date: Mar. 16, 2022

Related U.S. Application Data
(60) Provisional application No. 63/014,375, filed on Apr. 23, 2020.
(60) Provisional application No. 63/003,588, filed on Apr. 1, 2020.
(60) Provisional application No. 62/901,481, filed on Sep. 17, 2019.
(60) Provisional application No. 62/901,723, filed on Sep. 17, 2019.

(51) Int. Cl. C01B 6/02; H01M 8/04082; C01B 3/00

(52) U.S. Cl. CPC C01B 6/02; H01M 8/04216; C01B 3/001

(57) ABSTRACT

The present invention relates to improved hydrogen storage materials and improved processes for their preparation. The hydrogen storage materials prepared by the processes described herein exhibit enhanced hydrogen storage capacity when used as hydrogen storage systems. The processes described herein may be undertaken on a commercial scale.

This application claims the benefit of U.S. Provisional Application No. 62/901,481, filed on Sep. 17, 2019, 62/901,723, filed on Sep. 17, 2019, 63/003,588, filed on Apr. 1, 2020, and 63/014,375, filed on Apr. 23, 2020, each of which is incorporated herein by reference in its entirety.

### FIELD OF THE INVENTION

The present invention relates to improved hydrogen storage materials and improved processes for their preparation. The hydrogen storage materials prepared by the processes described herein exhibit enhanced hydrogen storage capacity when used as hydrogen storage systems. The processes described herein may be undertaken on a commercial scale.

### BACKGROUND OF THE INVENTION

The enormous demands placed on the world's fossil fuel reserves have led to concerns regarding global warming, energy security and environmental pollution. Researchers continue to seek alternative fuel sources. Molecular hydrogen is ideal in this regard because it is lightweight, abundant, has more than three times the energy density by mass than currently used hydrocarbon fuels such as gasoline, and its only combustion product (water) is environmentally benign. Despite the advances made in fuel cell technology and hydrogen production, storage remains a great hurdle. See, e.g., R. H. Wiswall et al., Science, 186, 1158, 1974; S. Orimo et al., Chem. Rev., 107, 4111, 2007, and L. K. Heung, On-board Hydrogen Storage System Using Metal Hydride, HYPOTHESIS II, 1, 1997. Using current technology, hydrogen storage has a low energy storage density by volume relative to hydrocarbon fuels. Therefore, with all other factors being equal, in order to store the same amount of energy, hydrogen storage requires a much larger and heavier storage tank than hydrocarbon fuel storage.

Gravimetric capacity is a measure of the amount of hydrogen that can be stored per unit mass of the storage system. Volumetric capacity is a measure of the amount hydrogen that can be stored per unit volume of the storage system. The United States Department of Energy (DOE) has set targets for hydrogen storage. The 2017 target set by the DOE for hydrogen storage is 5.5 wt. % and 40 kg/m³ volumetric adsorption for a fully reversible system operating near room temperature. The ultimate goals are 7.5 wt % and 70 kg/m³.

Some technologies being considered involve the use of chemical carriers such as alloys, adsorbents such as amorphous carbons (see, e.g., R. Yang et al., J. Am. Chem. Soc., 131, 4224, 2009), zeolites (see, e.g., A. Pacula, et al., J. Phys. Chem. C, 112, 2764, 2008) and metal organic frameworks (MOFs)(see, e.g., K. M. Thomas, Dalton Trans., 1487, 2009; S. S. Kaye et al., J. Am. Chem. Soc., 129, 14176, 2007, and N. L. Rosi et al., Science, 300, 1127, 2003).

The use of metal hydrides, such as LiH and NaAlH₄ is thwarted by heat management issues and problems with slow kinetics and/or reversibility. For example, when hydrogen reacts with magnesium or a sodium-aluminum alloy to give a metal hydride such as MgH₂ and NaAlH₄, significant amounts of heat are given off. When this heat is produced, a cooling step must be carried out to prevent a significant rise in temperature in the system, and this cooling step constitutes an energy loss to the system. Furthermore, heating is typically necessary to remove the hydrogen when required. This is an artifact of the high enthalpies of hydrogen binding (>60 kJ/mol) typical of hydrides such as MgH₂ and NaAlH₄.

Compression techniques have been used to increase gas pressure and improve the energy storage density by volume for hydrogen. This allows for the storage tanks to be smaller. However, compressing hydrogen requires a significant amount of energy, often accounting for as much as 30% of the stored energy. Furthermore, large pressure vessels are required for such compression techniques.

Another technique for storing hydrogen involves converting hydrogen gas to liquid hydrogen. This technique requires cryogenic storage because hydrogen has a very low boiling point (−252.88° C.). The liquefaction of hydrogen requires a large amount of energy to maintain these extremely low temperatures. Furthermore, the storage tank for liquid hydrogen requires complex and expensive insulation in order to prevent the liquid hydrogen from evaporating. In addition, liquid hydrogen has a lower energy density by volume than hydrocarbon fuels, such as gasoline, by a factor of about 4.

Physisorption materials, such as amorphous carbons and metal organic frameworks (MOFs), achieve promising storage capacities at temperatures of 77 K, but typically lose approximately 90% of their performance at room temperature due to low heats of adsorption (typically 5-13 kJ/mol H₂). See, e.g., A. Dailly et al., J. Phys. Chem. B, 110, 1099, 2006, J. Rowsell et al., Angew. Chem., Int. Ed., 2005, 4670, 2005. In order to achieve the DOE target under ambient conditions, the ideal H₂ binding energy is predicted to be in the range of 20-30 kJ/mol per hydrogen molecule. See, e.g., R. Lochan et al., Phys. Chem. Chem. Phys., 8, 1357, 2006. Moreover, energy production costs for the preparation of hydrogen storage materials may be an important factor.

There is therefore a need for improved, lower cost materials that can be used as hydrogen storage systems. Additionally, there is a need for improved methods to synthesize materials of higher purity that exhibit enhanced hydrogen storage capacity when used as hydrogen storage systems.

### SUMMARY OF THE INVENTION

The inventor has developed improved metal hydride compounds useful in hydrogen storage applications and processes for their preparation. The improved processes involve, in one aspect, thermal and/or photochemical precipitation of metal hydrocarbon compounds (e.g., metal alkyl and/or metal aryl compounds) in the absence of hydrogen in the presence of (a) an inert solvent, (b) a solvent without a β-hydrogen, or a combination thereof to form a precipitated hydrogen storage material precursor. In one aspect, the alkyl and/or aryl groups do not contain a β-hydrogen substituent. As a result, the solvent and the alkyl/aryl groups do not undergo β-hydride elimination. In another aspect, transition metal carbonyl starting materials may be utilized. The resulting precipitate may then be hydrogenated to form the metal hydride (hydrogenated precipitate) hydrogen storage material.

The inventor has surprisingly found that the initial themal and/or photochemical precipitation process forms an intermediate containing residual hydrocarbon, in what is believed to be, without wishing to be bound by theory, bridging modes. Again, without wishing to be bound by theory, the inventor theorizes that the precipitation process forms a polymer by α-elimination (e.g., α-elimination of tetramethylsilane and subsequent polymerization in the case of a bis[(trimethylsilyl)methyl] compound) to form a bridging alkylidene structure, or γ-methyl group activation and subsequent polymerization to form a species such as -M-CH₂—Si(CH₃)₂)—CH₂-M-, where M is a metal such as manganese) or, in the case of a metal aryl compound, by condensation via bimolecular C—H activation and subsequent hydrocarbon elimination (i.e., bimolecular sigma bond metathesis). It is believed that these bridging ligands create space in the downstream amorphous structure, effectively acting as templates to ensure that molecular hydrogen (H₂) can diffuse in and out of the structure once the bridging hydrocarbon is removed. Hydrogenation of the precipitate subsequently removes residual hydrocarbon. Again, without wishing to be bound by theory, the inventor theorizes that the resulting metal hydride (hydrogenated precipitate) contains bridging hydride ligands. The inventor has surprisingly found that metal hydride formation is only desirable in the later stages of the synthesis, i.e., following precipitation of the intermediate polymeric species (the hydrogen storage material precursor). Hydride formation at too early a stage leads to a close-packed structure having low porosity and diminished hydrogen storage capacity.

The processes described herein are efficient and, importantly, are readily commerically scalable. Additionally, the use of solvents such as supercritical xenon allows the reactions to be preformed at lower temperatures and higher concentrations, allowing for shorter reaction times with fewer side-reactions and inactive by-product formation.

Furthermore, and again without wishing to be bound by theory, the inventor theorizes that when using supercritical solvents such as, for example, supercritical Xe or supercritical Kr, the Xe or Kr is able to penetrate the polymer structure and passively stabilize the incipient pore structure during hydrogenation and conversion of the polymeric structure (such as —R—Mn—R—) to the metal hydride (MnHₓ). This is because Xe and Kr can weakly coordinate to Mn and also fill empty void space with a Xe or Kr phase of variable density. When depressurising the Xe/H₂ or Kr/H₂ mixture, there is no phase change between newly formed hydrocarbon which was in the solid state, but now could be in the gas phase (ie M-R+H₂→M-H and R—H). This prevents a sudden “explosion” and cracking or collapsing of the pore structure. This is because there is no phase change in a supercritical fluid. Additional benefits of using a supercritical fluid as a solvent include that it has a broad range of densities (unlike a liquid), is completely inert, weakly coordinating to transition metals, and is also capable of dissolving a broad range of organometallic polymers, which are sparingly soluble in hydrocarbons. For example, having a higher concentration of dialkyl or diaryl manganese complex in an inert supercritical fluid would favour a faster and more selective condensation reaction with the possibilities of higher temperatures (i.e., faster reactions) without side reactions. Additionally, supercritical Xe and Kr are known to be superior solvents for C—H activation reactions because they bind to the substrate more weakly than competing organic solvent molecules. This has been demonstrated by comparing reaction rates of organomanganese Xe, Kr, and heptane complexes. See, e.g., Grills et al., J. Phys. Chem. A., 104, 4300-4307, 2000.

Moreover, variation in reaction temperature, pressure, and synthesis times may be used to tune the final porosity and hydrogen storage properties (including volumetric and gravimetric density) of the final metal hydride storage material by controlling pore size. The present inventor has found that the composition of the metal hydride storage material is not the only factor that governs its hydrogen storage properties. Controlling the nanostructure of the metal hydride storage material is also important to tuning its hydrogen storage activity.

Furthermore, the processes described herein allow for formation of a hydrogen storage material (metal hydride) monolith, (e.g., a solid block of hydrogen storage material (metal hydride) as opposed to a powder) which can be maintained in the synthesis vessel (which may be the storage system itself, i.e., any of the reactions described herein may be performed directly in the storage system) and used as is in the storage system, or removed and stacked with other monoliths in a different storage system. Tuning the pore structure, density, and hydrogen storage properties of the final monolith in situ with pressure, concentration, temperature of the supercritical solvent, and hydrogen pressure, etc. allows for a convenient one-step route which avoids having to pelletize the hydrogen storage material (metal hydride) and pack it into storage tanks. See, e.g., Hebb et al., Chem. Mater., 15, 2016-2069, 2003; Cooper et al., Adv. Mater., 15(13), 1049-1059, 2003.

The metal hydrides (hydrogenated precipitates) prepared by the processes described herein exhibit enhanced hydrogen storage capacity and permit the metal centres to form interactions (e.g., Kubas interactions) with multiple H₂ molecules to form solid state hydrides, and can reversibly release hydrogen, thereby acting as materials for hydrogen storage.

In a first aspect, the present invention relates to a process for preparing a hydrogen storage material precursor, the process comprising:

precipitating a manganese compound having one or more substituted or unsubstituted alkyl groups, substituted or unsubstituted aryl groups, or a combination thereof bound to the manganese via metal-carbon sigma bonds from (a) an inert solvent, (b) a solvent without a β-hydrogen, or a combination thereof,

wherein (i) the substituted or unsubstituted alkyl or substituted or unsubstituted aryl groups in the manganese compound do not have a β-hydrogen, and (ii) the precipitate when hydrogenated results in a material in which the manganese has an oxidation state of from 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of absorbing H₂ via a Kubas interaction.

In a second aspect, the present invention relates to a process for a process for preparing a hydrogen storage material, the process comprising:

(i) precipitating a manganese compound having one or more substituted or unsubstituted alkyl groups, substituted or unsubstituted aryl groups, or a combination thereof from (a) an inert solvent, (b) a solvent without a β-hydrogen, or a combination thereof, and

(ii) hydrogenating the precipitate,

wherein the manganese in the hydrogenated precipitate has an oxidation state of from 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogen storage material is capable of absorbing H₂ via a Kubas interaction.

In certain embodiments of the first and second aspects, the precipitation results in condensation of an initial manganese compound (such as, e.g., (Me₃Si—CH₂)₂Mn).

In certain embodiments of the first and second aspects, the precipitate is prepared from a manganese compound that has two substituted or unsubstituted alkyl groups, and each substituted or unsubstituted alkyl group is linked to the manganese via a 2-electron 2-center single bond.

In certain embodiments of the first and second aspects, the metal-carbon sigma bonds are not 3-center 2-electron bonds.

In certain embodiments of the first and second aspects, the precipitate is prepared from a manganese compound that is (Me₃Si—CH₂)₂Mn.

In certain embodiments of the first and second aspects, the solvent is an inert solvent (e.g., supercritical xenon, supercritical krypton, supercritical methane or supercritical CO₂, or any combination thereof.

In certain embodiments of the first and second aspects, the solvent is a solvent a solvent without a β-hydrogen.

In certain embodiments of the first and second aspects, the solvent is not toluene.

In certain embodiments of the first and second aspects, the solvent is selected from supercritical xenon, supercritical krypton, supercritical methane, supercritical CO₂, a tetralkylsilane (e.g., tetramethylsilane), adamantane, cubane, neopentane, xylene, trimethylbenzene (e.g., 1,3,5-trimethylbenzene), and any combination thereof.

In certain embodiments of the first and second aspects, the solvent is 1,3,5-trimethylbenzene.

In certain embodiments of the first and second aspects, the concentration of the manganese compound in the solvent is greater than about 3.1 g/100 mL.

In certain embodiments of the first and second aspects, the concentration of the manganese compound in the solvent is greater than about 4 g/100 mL.

In certain embodiments of the first and second aspects, the concentration of the manganese compound in the solvent is greater than about 5 g/100 mL.

In certain embodiments of the first and second aspects, the concentration of the manganese compound in the solvent is from about 3.5 mg/100 mL to about 50 mg/mL.

In certain embodiments of the first and second aspects, the concentration of the manganese compound in the solvent is about 3.5 mg/100 mL, about 4 mg/100 mL, about 5 mg/100 mL, about 7.5 mg/100 mL, about 10 mg/100 mL, about 15 mg/100 mL, about 20 mg/100 mL, about 25 mg/100 mL, about 30 mg/100 mL, about 35 mg/100 mL, about 40 mg/100 mL, about 45 mg/100 mL or about 50 mg/100 mL.

In certain embodiments of the first and second aspects, the precipitating step is performed in the absence of H₂.

In certain embodiments of the first and second aspects, the precipitating step involves thermal precipitation, photochemical precipitation, or a combination thereof.

In certain embodiments of the first and second aspects, the precipitating step comprises heating the manganese compound and isolating the precipitate.

In certain embodiments of the first and second aspects, the manganese compound is heated to about 50° C. to about 250° C.

In certain embodiments of the first and second aspects, the manganese compound is heated to about 110° C. to about 250° C.

In certain embodiments of the first and second aspects, the manganese compound is heated to about 80° C. to about 110° C.

In certain embodiments of the first and second aspects, the precipitate weighs greater than about 40% of the original weight of the manganese compound.

In certain embodiments of the first and second aspects, the precipitate weighs greater than about 50% of the original weight of the manganese compound.

In certain embodiments of the first and second aspects, the precipitate weighs greater than about 60% of the original weight of the manganese compound.

In certain embodiments of the first and second aspects, the precipitate weighs greater than about 40%, such as greater than about 45%, greater than about 50%, greater than about 55%, or greater than about 60% of the original weight of the manganese compound.

In certain embodiments of the first and second aspects, the precipitate contains greater than about 40% by weight of residue other than manganese.

In certain embodiments of the first and second aspects, the precipitate contains greater than about 50% by weight of residue other than manganese.

In certain embodiments of the first and second aspects, the precipitate contains greater than about 60% by weight of residue other than manganese.

In certain embodiments of the first and second aspects, the precipitate contains greater than about 40%, such as greater than about 45%, greater than about 50%, greater than about 55% or greater than about 60% by weight of residue other than manganese.

In another embodiment of the first aspect, the present invention relates to a process for preparing a hydrogen storage material, the process comprising:

(a) precipitating a manganese compound having one or more substituted or unsubstituted alkyl groups, substituted or unsubstituted aryl groups, or a combination thereof bound to the manganese via metal-carbon sigma bonds from a solvent selected from supercritical Xe, supercritical krypton, supercritical methane, supercritical CO₂, or a combination thereof; and

(b) hydrogenating the precipitate, optionally in a solvent selected from supercritical Xe, supercritical krypton, supercritical methane, supercritical CO₂, or a combination thereof;

wherein (i) the substituted or unsubstituted alkyl or substituted or unsubstituted aryl groups in the manganese compound do not have a β-hydrogen, and (ii) the hydrogenated precipitate is a material in which the manganese has an oxidation state of from 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of absorbing H₂ via a Kubas interaction.

In one embodiment, both step (a) and step (b) are conducted in a solvent selected from supercritical Xe, supercritical krypton, supercritical methane, supercritical CO₂, or a combination thereof.

In another embodiment, both step (a) and step (b) are performed in one reaction vessel.

In another embodiment, step (b) is performed without isolating the product of step (a).

In another embodiment of the first aspect, the present invention relates to a process for preparing a hydrogen storage material, the process comprising:

(a) hydrogenating a manganese compound having one or more substituted or unsubstituted alkyl groups, substituted or unsubstituted aryl groups, or a combination thereof bound to the manganese via metal-carbon sigma bonds in a solvent selected from supercritical Xe, supercritical krypton, supercritical methane, supercritical CO₂, or a combination thereof;

(b) optionally isolating the product of step (a); and

(c) optionally, further hydrogenating the hydrogenated manganese compound, optionally in a solvent selected from supercritical Xe, supercritical krypton, supercritical methane, supercritical CO₂, or a combination thereof;

wherein (i) the substituted or unsubstituted alkyl or substituted or unsubstituted aryl groups in the manganese compound do not have a f-hydrogen, and (ii) the hydrogenated manganese compound is a material in which the manganese has an oxidation state of from 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of absorbing H₂ via a Kubas interaction.

In one embodiment, both step (a) and step (c) are conducted in a solvent selected from supercritical Xe, supercritical krypton, supercritical methane, supercritical CO₂, or a combination thereof.

In another embodiment, step (a) and step (c) are performed in one reaction vessel.

In another embodiment, step (b) is not performed.

In another embodiment of the second aspect, the present invention relates to a process for preparing a hydrogen storage material, the process comprising:

(i) precipitating a manganese compound having one or more substituted or unsubstituted alkyl groups, substituted or unsubstituted aryl groups, or a combination thereof from a solvent selected from supercritical Xe, supercritical krypton, supercritical methane, supercritical CO₂, or a combination thereof;

(ii) hydrogenating the precipitate, optionally in a solvent selected from supercritical Xe, supercritical krypton, supercritical methane, supercritical CO₂, or a combination thereof; wherein the manganese in the hydrogenated precipitate has an oxidation state of from 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogen storage material is capable of absorbing H₂ via a Kubas interaction.

In one embodiment, both step (i) and step (ii) are conducted in a solvent selected from supercritical Xe, supercritical krypton, supercritical methane, supercritical CO₂, or a combination thereof.

In another embodiment, both step (i) and step (ii) are performed in one reaction vessel.

In another embodiment, step (ii) is performed without isolating the product of step (i).

In certain embodiments of the first and second aspects, the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the first and second aspects, the hydrogenated material comprises MnHₓ (optionally further comprising residual hydrocarbon and/or solvent) where x is 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of reversibly storing more than two H₂ molecules per Mn.

In certain embodiments of the first and second aspects, the manganese in the hydrogenated material comprises Mn(I) and Mn(II).

In certain embodiments of the first and second aspects, the manganese in the hydrogenated material comprises Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the first and second aspects, the manganese in the hydrogenated material comprises Mn(0), Mn(I) and Mn(II).

In certain embodiments of the first and second aspects, the manganese in the hydrogenated material comprises Mn(0), Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3), and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the first and second aspects, the precipitate is formed by condensation of the manganese compound.

In certain embodiments of the first and second aspects, the hydrogenated material is a bulk solid.

In certain embodiments of the first and second aspects, the hydrogenated material is stable at room temperature.

In certain embodiments of the first and second aspects, the hydrogenated material is stable at room temperature as a bulk solid.

In certain embodiments of the first and second aspects, the hydrogenated material further comprises one or more additional metals, such as one or more metals in addition to manganese.

In certain embodiments of the first and second aspects, the one or more additional metals are selected from niobium, molybdenum, technetium, ruthenium, rhodium, palladium, silver, iron, zirconium, zinc, gallium, cadmium, hafnium, tantalum, tungsten, rhenium, osmium, iridium, platinum, gold, mercury, and any combination thereof.

In certain embodiments of the first and second aspects, the process further comprises (i) subjecting the hydrogenated material to vacuuming, heating, or both, and optionally (ii) repeating one or more times (a) hydrogenation of the vacuumed and/or heated material and (b) subjecting the hydrogenated material to vacuuming, heating, or both.

Another aspect of the present invention is a hydrogen storage material (metal hydride) obtained by the process according to any of the embodiments of the first and second aspects described herein.

In a third aspect, the present invention relates to a process for preparing a condensation product of a transition metal compound, the process comprising:

precipitating, from (a) an inert solvent, (b) a solvent without a β-hydrogen, or a combination thereof, in the absence of hydrogen, a transition metal compound having one or more substituted or unsubstituted alkyl groups, substituted or unsubstituted aryl groups, or a combination thereof, bound to the transition metal via metal-carbon sigma bonds,

wherein (i) the substituted or unsubstituted alkyl or substituted or unsubstituted aryl groups in the precipitate do not have a β-hydrogen, and (ii) the precipitate when hydrogenated results in a material that is capable of absorbing H₂ via a Kubas interaction.

In one embodiment of the third aspect, the transition metal is not manganese.

In one embodiment of the third aspect, the precipitating step comprises:

(a) heating the transition metal compound in the solvent in the absence of hydrogen to form a precipitate; and

(b) optionally isolating the precipitate.

In one embodiment of the third aspect, the precipitate has two substituted or unsubstituted alkyl groups, and each substituted or unsubstituted alkyl group is linked to the manganese via a 2-electron 2-center single bond.

In one embodiment of the third aspect, the metal-carbon sigma bonds are not 3-center 2-electron bonds.

In one embodiment of the third aspect, the precipitate weighs greater than about 40% of the original weight of the transition metal compound.

In one embodiment of the third aspect, the precipitate weighs greater than about 50% of the original weight of the transition metal compound.

In one embodiment of the third aspect, the precipitate weighs greater than about 60% of the original weight of the transition metal compound.

In one embodiment of the third aspect, the precipitate weighs greater than about 40%, such as greater than about 45%, greater than about 50%, greater than about 55%, or greater than about 60% of the original weight of the transition metal compound.

In one embodiment of the third aspect, the precipitate contains greater than about 40% by weight of residue other than the transition metal.

In one embodiment of the third aspect, the precipitate contains greater than about 50% by weight of residue other than the transition metal.

In one embodiment of the third aspect, the precipitate contains greater than about 60% by weight of residue other than the transition metal.

In one embodiment of the third aspect, the precipitate contains greater than about 40%, such as greater than about 45%, greater than about 50%, greater than about 55% or greater than about 60% by weight of residue other than the transition metal.

In one embodiment of the third aspect, the solvent does not contain a reactive β-hydrogen substituent.

In one embodiment of the third aspect, the solvent is selected from a supercritical solvent (e.g., supercritical xenon, supercritical krypton, supercritical methane, supercritical CO₂), tetralkylsilane (e.g., tetramethylsilane), adamantane, cubane, neopentane, xylene, trimethylbenzene (e.g., 1,3,5-trimethylbenzene) and any combination thereof.

In one embodiment of the third aspect, the solvent is selected from a supercritical solvent (e.g., supercritical xenon, supercritical krypton, supercritical methane, supercritical CO₂, or a combination thereof).

In one embodiment of the third aspect, the alkyl group in the precipitate is a silylated alkyl group.

In one embodiment of the third aspect, the alkyl group in the precipitate is selected from mesityl, neopentyl, trimethylsilylmethyl, and any combination thereof.

In one embodiment of the third aspect, the aryl group in the precipitate is benzyl, optionally substituted with one or more alkyl (e.g., methyl) groups.

In one embodiment of the third aspect, the transition metal is a first-row transition metal.

In one embodiment of the third aspect, the the transition metal is selected from titanium, vanadium, chromium, manganese, iron, cobalt, nickel and copper.

In one embodiment of the third aspect, the transition metal is manganese.

In one embodiment of the third aspect, the transition metal alkyl compound or the transition metal aryl compound further comprises one or more additional metals.

In one embodiment of the third aspect, the one or more additional metals are selected from niobium, molybdenum, technetium, ruthenium, rhodium, palladium, silver, iron, zirconium, zinc, gallium, cadmium, hafnium, tantalum, tungsten, rhenium, osmium, iridium, platinum, gold, mercury, and any combination thereof.

In one embodiment of the third aspect, the precipitation is conducted at a temperature of about 50 to about 250° C., such as at a temperature of about 80 to about 110° C.

In one embodiment of the third aspect, the concentration of the transition compound in the solvent is greater than about 3.1 g/100 mL.

In one embodiment of the third aspect, the concentration of the transition metal compound in the solvent is greater than about 4 g/100 mL.

In one embodiment of the third aspect, the concentration of the transition metal compound in the solvent is at greater than about 5 g/100 mL.

In one embodiment of the third aspect, the concentration of the transition metal compound in the solvent is from about 3.5 mg/100 mL to about 50 mg/mL.

In one embodiment of the third aspect, the concentration of the transition metal compound in the solvent is about 3.5 mg/100 mL, about 4 mg/100 mL, about 5 mg/100 mL, about 7.5 mg/100 mL, about 10 mg/100 mL, about 15 mg/100 mL, about 20 mg/100 mL, about 25 mg/100 mL, about 30 mg/100 mL, about 35 mg/100 mL, about 40 mg/100 mL, about 45 mg/100 mL or about 50 mg/100 mL.

In one embodiment of the third aspect, the process further comprise hydrogenating the precipitate and, optionally, isolating the hydrogenated precipitate.

In another embodiment of the third aspect, the present invention relates to a process for preparing a hydrogen storage material, the process comprising:

(a) precipitating, from a solvent selected from supercritical Xe, supercritical krypton, supercritical methane, supercritical CO₂, or a combination thereof, in the absence of hydrogen, a transition metal compound having one or more substituted or unsubstituted alkyl groups, substituted or unsubstituted aryl groups, or a combination thereof, bound to the transition metal via metal-carbon sigma bonds, and

(b) hydrogenating the precipitate, optionally in a solvent selected from supercritical Xe, supercritical krypton, supercritical methane, supercritical CO₂, or a combination thereof; wherein (i) the substituted or unsubstituted alkyl or substituted or unsubstituted aryl groups in the precipitate do not have a β-hydrogen, and (ii) hydrogenated precipitate is a material that is capable of absorbing H₂ via a Kubas interaction.

In one embodiment, both step (a) and step (b) are conducted in a solvent selected from supercritical Xe, supercritical krypton, supercritical methane, supercritical CO₂, or a combination thereof.

In another embodiment, both step (a) and step (b) are performed in one reaction vessel.

In another embodiment, step (b) is performed without isolating the product of step (a).

In certain embodiments of the third aspect, the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the third aspect, the hydrogenated material comprises MnHₓ (optionally further comprising residual hydrocarbon and/or solvent) where x is 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of reversibly storing more than two H₂ molecules per Mn.

In certain embodiments of the third aspect, the transition metal is manganese, and the manganese in the hydrogenated material comprises Mn(I) and Mn(II).

In certain embodiments of the third aspect, the transition metal is manganese, and the manganese in the hydrogenated material comprises Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the third aspect, the transition metal is manganese, and the manganese in the hydrogenated material comprises Mn(0), Mn(I) and Mn(II).

In certain embodiments of the third aspect, the transition metal is manganese, and the manganese in the hydrogenated material comprises Mn(0), Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the third aspect, the hydrogenated material is a bulk solid.

In certain embodiments of the third aspect, the hydrogenated material is stable at room temperature.

In certain embodiments of the third aspect, the hydrogenated material is stable at room temperature as a bulk solid.

The present invention also relates to a condensation product of a transition metal alkyl compound or a transition metal aryl compound (precipitate) prepared by a process according to any one of the embodiments of the aspect described herein.

The present invention also relates to a metal hydride (hydrogenated precipitate) prepared by a process according to any one of the embodiments of the aspect described herein.

In a fourth aspect, the present invention relates to a process for preparing a hydrogen storage material precursor, the process comprising

(a) preparing, in (a) an inert solvent, (b) a solvent without a β-hydrogen, or a combination thereof, a compound formed by

(i) reacting a compound of formula M¹X₂ with a compound of formula M²-CH₂—R—CH₂-M²; or

(ii) reacting a compound of formula M¹X₂ with a compound of formula M³(CH₂—R—CH₂); and

(iii) optionally precipitating the product of step (i) or step (ii) if a precipitate does not form in step (i) or step (ii); and

b) optionally isolating the product of step (a);

wherein

each M¹ is independently selected from titanium, vanadium, chromium, manganese, iron, cobalt, nickel and copper (preferably manganese),

each M² is, independently, selected from MgX, Li, K and Na (preferably Li),

M³ is Zn or Mg,

R is a substituted or unsubstituted alkylene or substituted or unsubstituted arylene group that does not contain a β-hydrogen substituent,

X is a halogen (e.g., Cl, Br, I, preferably I), and

wherein the precipitate, when hydrogenated, results in a material that is capable of absorbing H₂ via a Kubas interaction.

In one embodiment of the fourth aspect, step (a) is conducted in a solvent selected from a supercritical solvent (e.g., supercritical xenon, supercritical krypton, supercritical methane, supercritical CO₂), adamantane, cubane, trimethylbenzene (e.g., 1,3,5-trimethylbenzene), a tetralkylsilane (e.g., tetramethylsilane), diethyl ether, pentane, hexane, heptane, octane, petroleum ether, toluene and any combination thereof (preferably diethyl ether).

In one embodiment of the fourth aspect, step (a) is conducted in a solvent selected from a supercritical solvent (e.g., supercritical xenon, supercritical krypton, supercritical methane, supercritical CO₂, or a combination thereof).

In one embodiment of the fourth aspect, the concentration of the compound of formula M¹X₂ in the solvent is greater than about 3.1 g/100 mL.

In one embodiment of the fourth aspect, the concentration of the compound of formula M¹X₂ in the solvent is greater than about 4 g/100 mL.

In one embodiment of the fourth aspect, the concentration of the compound of formula M¹X₂ in the solvent is greater than about 5 g/100 mL.

In one embodiment of the fourth aspect, the concentration of the compound of formula M¹X₂ in the solvent is from about 3.5 mg/100 mL to about 50 mg/mL.

In one embodiment of the fourth aspect, the concentration of the compound of formula M¹X₂ in the solvent is about 3.5 mg/100 mL, about 4 mg/100 mL, about 5 mg/100 mL, about 7.5 mg/100 mL, about 10 mg/100 mL, about 15 mg/100 mL, about 20 mg/100 mL, about 25 mg/100 mL, about 30 mg/100 mL, about 35 mg/100 mL, about 40 mg/100 mL, about 45 mg/100 mL or about 50 mg/100 mL In one embodiment of the fourth aspect, the precipitate contains greater than about 40% by weight of residue other than M¹.

In one embodiment of the fourth aspect, the precipitate contains greater than about 50% by weight of residue other than M¹.

In one embodiment of the fourth aspect, the precipitate contains greater than about 60% by weight of residue other than M¹.

In one embodiment of the fourth aspect, the precipitate contains greater than about 40%, such as greater than about 45%, greater than about 50%, greater than about 55% or greater than about 60% by weight of residue other than M¹.

In one embodiment of the fourth aspect, the solvent does not contain a β-hydrogen substituent.

In one embodiment of the fourth aspect, the precipitate contains alkylene groups of the formula —CH₂—Y—CH₂—, wherein Y is an optionally silylated alkylene or optionally silylated arylene group.

In one embodiment of the fourth aspect, the alkylene group is a silylated alkylene group.

In one embodiment of the fourth aspect, the alkylene group is —CH₂Si(CH₃)₂CH₂—.

In one embodiment of the fourth aspect, the precipitate contains aryl groups of the formula —CH₂(phenylene)CH₂—, wherein the phenylene is optionally substituted with one or more alkyl (e.g., CH₃) groups.

In one embodiment of the fourth aspect, M¹ is manganese.

In one embodiment of the fourth aspect, M¹ is manganese, X is I and the solvent is diethyl ether.

In one embodiment of the fourth aspect, the process further comprises

(c) hydrogenating the product of step (a) or step (b) to form a metal hydride; and

(d) optionally isolating the metal hydride.

In another embodiment of the fourth aspect, the present invention relates to a process for preparing a hydrogen storage material, the process comprising

(a) preparing, in a solvent selected from supercritical Xe, supercritical krypton, supercritical methane, supercritical CO₂, or a combination thereof, a compound formed by

(i) reacting a compound of formula M¹X₂ with a compound of formula M²-CH₂—R—CH₂-M²; or

(ii) reacting a compound of formula M¹X₂ with a compound of formula M³(CH₂—R—CH₂); and

(iii) optionally precipitating the product of step (i) or step (ii) if a precipitate does not form in step (i) or step (ii); and

b) optionally isolating the product of step (a); and

c) hydrogenating the product of step (a), optionally in a solvent selected from supercritical Xe, supercritical krypton, supercritical methane, supercritical CO₂, or a combination thereof

wherein

each M¹ is independently selected from titanium, vanadium, chromium, manganese, iron, cobalt, nickel and copper (preferably manganese),

each M² is, independently, selected from MgX, Li, K and Na (preferably Li), M³ is Zn or Mg,

R is a substituted or unsubstituted alkylene or substituted or unsubstituted arylene group that does not contain a β-hydrogen substituent,

X is a halogen (e.g., Cl, Br, I, preferably I), and wherein the hydrogen storage material is capable of absorbing H₂ via a Kubas interaction.

In one embodiment, both step (a) and step (c) are conducted in a solvent selected from supercritical Xe, supercritical krypton, supercritical methane, supercritical CO₂, or a combination thereof.

In one embodiment, step b) is not conducted.

In another embodiment, both step (a) and step (c) are performed in one reaction vessel.

In another embodiment, step (c) is performed without isolating the product of step (a).

In another embodiment of the fourth aspect, the present invention relates to a process for preparing a hydrogen storage material, the process comprising

(a) preparing, under one or more atmospheres of hydrogen, and in a solvent selected from supercritical Xe, supercritical krypton, supercritical methane, supercritical CO₂, or a combination thereof, a compound formed by

(i) reacting a compound of formula M¹X₂ with a compound of formula M²-CH₂—R—CH₂-M²; or

(ii) reacting a compound of formula M¹X₂ with a compound of formula M³(CH₂—R—CH₂);

b) optionally isolating the product of step (a); and

c) optionally, further hydrogenating the product of step (a), optionally in a solvent selected from supercritical Xe, supercritical krypton, supercritical methane, supercritical CO₂, or a combination thereof

wherein

each M¹ is independently selected from titanium, vanadium, chromium, manganese, iron, cobalt, nickel and copper (preferably manganese),

each M² is, independently, selected from MgX, Li, K and Na (preferably Li), M³ is Zn or Mg,

R is a substituted or unsubstituted alkylene or substituted or unsubstituted arylene group that does not contain a β-hydrogen substituent,

X is a halogen (e.g., Cl, Br, I, preferably I), and wherein the hydrogen storage material is capable of absorbing H₂ via a Kubas interaction

In one embodiment, both step (a) and step (c) are conducted in a solvent selected from supercritical Xe, supercritical krypton, supercritical methane, supercritical CO₂, or a combination thereof.

In one embodiment, step b) is not conducted.

In another embodiment, both step (a) and step (c) are performed in one reaction vessel.

In certain embodiments of the fourth aspect, the hydrogenated material comprises MnHₓ (optionally further comprising residual halide, M², M³, hydrocarbon, solvent, or any combination thereof) where x is 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of reversibly storing more than two H₂ molecules per Mn.

In one embodiment of the fourth aspect, the hydrogenated material further comprises one or more additional metals (i.e., one or more additional metals other than M¹).

In one embodiment of the fourth aspect, the one or more additional metals are selected from niobium, molybdenum, technetium, ruthenium, rhodium, palladium, silver, iron, zirconium, zinc, gallium, cadmium, hafnium, tantalum, tungsten, rhenium, osmium, iridium, platinum, gold, mercury, and any combination thereof.

In certain embodiments of the fourth aspect, M¹ is manganese, and the manganese in the hydrogenated material comprises Mn(I) and Mn(II).

In certain embodiments of the fourth aspect, M¹ is manganese, and the manganese in the hydrogenated material comprises Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the fourth aspect, M¹ is manganese, and the manganese in the hydrogenated material comprises Mn(0), Mn(I) and Mn(II).

In certain embodiments of the fourth aspect, M¹ is manganese, and the manganese in the hydrogenated material comprises Mn(0), Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the fourth aspect, the hydrogenated material is a bulk solid.

In certain embodiments of the fourth aspect, the hydrogenated material is stable at room temperature.

In certain embodiments of the fourth aspect, the hydrogenated material is stable at room temperature as a bulk solid.

The present invention also relates to a hydrogen storage material prepared by a process according to any one of the embodiments of the aspect described herein.

The present invention also relates to a metal hydride (hydrogenated precipitate) prepared by a process according to any one of the embodiments of the aspect described herein.

In a fifth aspect, the present invention relates to a process for preparing a hydrogen storage material precursor, the process comprising

(a)
(i) heating a compound of formula M¹R₂ in a solvent selected from supercritical, Xe, supercritical krypton, supercritical methane, supercritical CO₂, xylene, 1,3,5-trimethylbenzene, a tetraalkylsilane, a tetraarylsilane, and any combination thereof, in the absence of hydrogen;
(ii) optionally precipitating the product of step (i) if a precipitate does not form in step (i); and

(b) optionally isolating the product of step (a);

wherein

M¹ is independently selected from titanium, vanadium, chromium, manganese, iron, cobalt, nickel and copper, and

R is a substituted or unsubstituted alkyl or substituted or unsubstituted aryl group that does not contain a β-hydrogen substituent.

In one embodiment of the fifth aspect, step (a) is conducted in a solvent selected from xylene, 1,3,5-trimethylbenzene, a tetraalkylsilane, a tetraarylsilane In one embodiment of the fifth aspect, the precipitate weighs greater than about 40% of the original weight of the M¹R₂.

In one embodiment of the fifth aspect, the precipitate weighs greater than about 50% of the original weight of the M¹R₂.

In one embodiment of the fifth aspect, the precipitate weighs greater than about 60% of the original weight of the M¹R₂.

In one embodiment of the fifth aspect, the precipitate weighs greater than about 40%, such as greater than about 45%, greater than about 50%, greater than about 55%, or greater than about 60% of the original weight of the M¹R₂.

In one embodiment of the fifth aspect, the precipitate contains greater than about 40% by weight of residue other than M¹.

In one embodiment of the fifth aspect, the precipitate contains greater than about 50% by weight of residue other than M¹.

In one embodiment of the fifth aspect, the precipitate contains greater than about 60% by weight of residue other than M¹.

In one embodiment of the fifth aspect, the precipitate contains greater than about 40%, such as greater than about 45%, greater than about 50%, greater than about 55% or greater than about 60% by weight of residue other than M¹.

In one embodiment of the fifth aspect, the alkylene group is of the formula —CH₂—Y—CH₂—, wherein Y is an optionally silylated alkylene or optionally silylated arylene group.

In one embodiment of the fifth aspect, the alkylene group is a silylated alkylene group.

In one embodiment of the fifth aspect, the alkylene group is —CH₂Si(CH₃)₂CH₂—. In one embodiment of the fifth aspect, the aryl group is —CH₂(phenylene)CH₂—, wherein the phenylene is optionally substituted with one or more alkyl (e.g., CH₃) groups.

In one embodiment of the fifth aspect, the transition metal is manganese.

In one embodiment of the fifth aspect, the concentration of the compound of formula M¹R₂ in the solvent is greater than about 3.1 g/100 mL.

In one embodiment of the fifth aspect, the concentration of the compound of formula M¹R₂ in the solvent is greater than about 4 g/100 mL.

In one embodiment of the fifth aspect, the concentration of the compound of formula M¹R₂ in the solvent is greater than about 5 g/100 mL.

In one embodiment of the fifth aspect, the concentration of the compound of formula M¹R₂ in the solvent is from about 3.5 mg/100 mL to about 50 mg/mL.

In one embodiment of the fifth aspect, the concentration of the compound of formula M¹R₂ in the solvent is about 3.5 mg/100 mL, about 4 mg/100 mL, about 5 mg/100 mL, about 7.5 mg/100 mL, about 10 mg/100 mL, about 15 mg/100 mL, about 20 mg/100 mL, about 25 mg/100 mL, about 30 mg/100 mL, about 35 mg/100 mL, about 40 mg/100 mL, about 45 mg/100 mL or about 50 mg/100 mL.

In one embodiment of the fifth aspect, the process further comprises

(c) hydrogenating the product of step (a) or step (b) to form a metal hydride; and

(d) optionally isolating the metal hydride.

In one embodiment of the fifth aspect, M¹ is manganese and the manganese has an oxidation state of from 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3).

In another embodiment of the fifth aspect, the present invention relates to a process for preparing a hydrogen storage material, the process comprising

(a)
(i) heating a compound of formula M¹R₂ in a solvent selected from supercritical Xe, supercritical krypton, supercritical methane, supercritical CO₂, or a combination thereof, in the absence of hydrogen;
(ii) optionally precipitating the product of step (i) if a precipitate does not form in step (i);

(b) optionally isolating the product of step (a); and

(c) hydrogenating the the product of step (a) or step (b), optionally in a solvent selected from supercritical Xe, supercritical krypton, supercritical methane, supercritical CO₂, or a combination thereof;

wherein

M¹ is independently selected from titanium, vanadium, chromium, manganese, iron, cobalt, nickel and copper, and

R is a substituted or unsubstituted alkyl or substituted or unsubstituted aryl group that does not contain a β-hydrogen substituent.

In one embodiment, steps (a), and (c) are conducted in a solvent selected from supercritical Xe, supercritical krypton, supercritical methane, supercritical CO₂, or a combination thereof.

In another embodiment, steps (a) and (c) are performed in one reaction vessel.

In another embodiment, step (c) is performed without isolating the product of step (a).

In another embodiment of the fifth aspect, the present invention relates to a process for preparing a hydrogen storage material, the process comprising

(a) heating a compound of formula M¹R₂ in a solvent selected from supercritical Xe, supercritical krypton, supercritical methane, supercritical CO₂, or a combination thereof, under one or more atmospheres of hydrogen;

(b) optionally isolating the product of step (a); and

(c) optionally, further hydrogenating the the product of step (a) or step (b), optionally in a solvent selected from supercritical Xe, supercritical krypton, supercritical methane, supercritical CO₂, or a combination thereof;

wherein

M¹ is independently selected from titanium, vanadium, chromium, manganese, iron, cobalt, nickel and copper, and

R is a substituted or unsubstituted alkyl or substituted or unsubstituted aryl group that does not contain a β-hydrogen substituent.

In one embodiment, steps (a), and (c) are conducted in a solvent selected from supercritical Xe, supercritical krypton, supercritical methane, supercritical CO₂, or a combination thereof.

In one embodiment, M¹ is manganese and each R is trimethysilylmethyl, i.e., M¹R₂ is bis(trimethylsilylmethyl)manganese.

In another embodiment, steps (a), and (c) are performed in one reaction vessel.

In another embodiment, step (c) is performed without isolating the product of step (a).

In one embodiment of the fifth aspect, the hydrogenated material further comprises one or more additional metals (i.e., one or more additional metals other than M¹).

In one embodiment of the fifth aspect, the one or more additional metals are selected from niobium, molybdenum, technetium, ruthenium, rhodium, palladium, silver, iron, zirconium, zinc, gallium, cadmium, hafnium, tantalum, tungsten, rhenium, osmium, iridium, platinum, gold, mercury, and any combination thereof.

In certain embodiments of the fifth aspect, the hydrogenated material comprises MnHₓ (optionally further comprising residual hydrocarbon and/or solvent) where x is 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of reversibly storing more than two H₂ molecules per Mn.

In certain embodiments of the fifth aspect, M¹ is manganese, and the manganese in the hydrogenated material comprises Mn(I) and Mn(II).

In certain embodiments of the fifth aspect, M¹ is manganese, and the manganese in the hydrogenated material comprises Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the fifth aspect, M¹ is manganese, and the manganese in the hydrogenated material comprises Mn(0), Mn(I) and Mn(II).

In certain embodiments of the fifth aspect, M¹ is manganese, and the manganese in the hydrogenated material comprises Mn(0), Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the fifth aspect, the hydrogenated material is a bulk solid.

In certain embodiments of the fifth aspect, the hydrogenated material is stable at room temperature.

In certain embodiments of the fifth aspect, the hydrogenated material is stable at room temperature as a bulk solid.

The present invention also relates to a hydrogen storage material precursor prepared by a process according to any one of the embodiments of the aspect described herein.

The present invention also relates to a metal hydride (hydrogenated precipitate) prepared by a process according to any one of the embodiments of the aspect described herein.

In a sixth aspect, the present invention relates to a process for preparing a hydrogen storage material precursor, the process comprising

(a)
(i) thermally and/or photochemically decomposing a transition metal compound of formula M¹ₐ(P)ₙR, optionally in the presence of (a) an inert solvent, (b) a solvent without a β-hydrogen, or a combination thereof, and, optionally, in the presence of hydrogen;
(ii) optionally precipitating the product of step (i) if a precipitate does not form in step (i); and

b) optionally isolating the product of step (a);

wherein

M¹ is selected from titanium, vanadium, chromium, manganese, iron, cobalt, nickel and copper (preferably manganese);

P is a π-acidic ligand (e.g., CO);

R is absent, hydrogen, substituted or unsubstituted alkyl or substituted or unsubstituted aryl;

a is 1 or 2; and

n is 1, 2, 3, 4, 5, 6, 7, 8, 9, or 10;

wherein the decomposition product when hydrogenated results in a material capable of absorbing H₂ via a Kubas interaction.

In one embodiment of the sixth aspect, P is selected from CO, N₂, CN, O₂, NO⁻, CO₂, olefins, carbenes, isocyanides, isothiocyanates, and any combination thereof. In one embodiment, P is CO. In one embodiment of the sixth aspect, the compound has the formula M¹ₐ(CO)ₙR.

In one embodiment of the sixth aspect, the compound of formula M¹ₐ(P)ₙR, is Mn(CO)₅R or Mn(CO)₁₀.

In one embodiment of the sixth aspect, R is absent, M¹ is manganese, a is 1 and n is 10, and step (a) (i) comprises thermally and/or photochemically decomposing Mn₂(CO)₁₀ in the presence of hydrogen.

In one embodiment of the sixth aspect, R is absent, M¹ is manganese, a is 1 and n is 10, and step (a) (i) comprises thermally and/or photochemically decomposing Mn₂(CO)₁₀ in the presence of hydrogen to afford the compound of formula M¹ₐ(CO)ₙR.

In one embodiment of the sixth aspect, R is not absent and the thermal and/or photochemical decomposition is performed in the absence of hydrogen. In one embodiment of the sixth aspect, R is not absent, M¹ is manganese, a is 1 and n is 5, and step (a) (i) comprises thermally and/or photochemically decomposing M¹ₐ(P)ₙR (such as Mn(CO)₅R) in the absence of hydrogen.

In one embodiment of the sixth aspect, the substituted or unsubstituted alkyl and/or substituted or unsubstituted aryl group does not contain a β-hydrogen substituent.

In one embodiment of the sixth aspect, step (a) is conducted in a solvent selected from a supercritical solvent (e.g., supercritical xenon, supercritical krypton, supercritical methane, supercritical CO₂) cyclohexane, neopentane, adamantane, cubane, xylene, trimethylbenzene (e.g., 1,3,5-trimethylbenzene), and any combination thereof.

In one embodiment of the sixth aspect, step (a) is conducted in a solvent selected from a supercritical solvent (e.g., supercritical xenon, supercritical krypton, supercritical methane, supercritical CO₂ or a combination thereof).

In one embodiment of the sixth aspect, the decomposition product weighs greater than about 40% of the original weight of the transition metal compound of formula M¹ₐ(P)ₙR.

In one embodiment of the sixth aspect, the decomposition product weighs greater than about 50% of the original weight of the transition metal compound of formula M¹ₐ(P)ₙR.

In one embodiment of the sixth aspect, the decomposition product weighs greater than about 60% of the original weight of the transition metal compound of formula M¹ₐ(P)ₙR.

In one embodiment of the sixth aspect, the decomposition product weighs greater than about 40%, such as greater than about 45%, greater than about 50%, greater than about 55%, or greater than about 60% of the original weight of the transition metal compound of formula M¹ₐ(P)ₙR.

In one embodiment of the sixth aspect, the decomposition product contains greater than about 40% by weight of residue other than M¹.

In one embodiment of the sixth aspect, the decomposition product contains greater than about 50% by weight of residue other than M¹.

In one embodiment of the sixth aspect, the decomposition product contains greater than about 60% by weight of residue other than M¹.

In one embodiment of the sixth aspect, the decomposition product contains greater than about 40%, such as greater than about 45%, greater than about 50%, greater than about 55% or greater than about 60% by weight of residue other than M¹

In one embodiment of the sixth aspect, the solvent does not contain a β-hydrogen substituent.

In one embodiment of the sixth aspect, the alkyl group is a silylated alkylene group.

In one embodiment of the sixth aspect, the alkylene group is —CH₂Si(CH₃)₃.

In one embodiment of the sixth aspect, the aryl group is —CH₂(phenylene), wherein the phenylene is optionally substituted with one or more alkyl (e.g., CH₃) groups.

In one embodiment of the sixth aspect, M¹ is manganese.

In one embodiment of the sixth aspect, the present invention relates to a compound of the formula M¹Hₓ(P)ₙR_{y} (e.g., MnHₓ(CO)ₙR_{y})

wherein

M¹ is selected from titanium, vanadium, chromium, manganese, iron, cobalt, nickel and copper (preferably manganese);

P is a π-acidic ligand (e.g., CO);

x is 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and;

R is absent, hydrogen, substituted or unsubstituted alkyl or substituted or unsubstituted aryl;

n is 0-5 (such as 0.01 to 5 or 0.1 to 5, e.g., 1, 2, 3, 4 or 5); and

y is 0-1 (e.g., 0.01 to 1, or 0.1 to 1).

In one embodiment of the sixth aspect, P is selected from CO, N₂, CN, O₂, NO⁻, CO₂, olefins, carbenes, isocyanides, isothiocyanates, and any combination thereof. In one embodiment, P is CO.

In one embodiment of the sixth aspect, the substituted or unsubstituted alkyl and/or substituted or unsubstituted aryl group in the compound of formula M¹Hₓ(P)ₙR_{y} (such as M¹Hₓ(CO)ₙR_{y}) does not contain a β-hydrogen substituent.

In one embodiment, the compound of the formula M¹Hₓ(P)ₙR_{y} (such as M¹Hₓ(CO)ₙR_{y}) is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %

In another embodiment of the sixth aspect, the present invention relates to a compound of the formula M¹Hₓ(P)ₙ(H₂)_{z}R_{y} (e.g., MnHₓ(P)ₙ(H₂)_{z}R_{y})

wherein

M¹ is selected from titanium, vanadium, chromium, manganese, iron, cobalt, nickel and copper (preferably manganese);

P is a π-acidic ligand (e.g., CO);

R is absent, hydrogen, substituted or unsubstituted alkyl or substituted or unsubstituted aryl;

x is 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and;

z is 0-4 (such as 0.01 to 4, 0.1 to 4, or 2.1 to 4, e.g., 1, 2, 3 or 4);

n is 0-5 (such as 0.01 to 5 or 0.1 to 5, e.g., 1, 2, 3, 4 or 5); and

y is 0-1 (e.g., 0.01 to 1, or 0.1 to 1).

In one embodiment, z is greater than 2.

In one embodiment of the sixth aspect, the substituted or unsubstituted alkyl and/or substituted or unsubstituted aryl group in the compound of formula M¹Hₓ(P)ₙ(H₂)_{z}R_{y} (such as M¹Hₓ(CO)ₙ(H₂)_{z}R_{y}) does not contain a β-hydrogen substituent.

In one embodiment of the sixth aspect, step (a) is conducted in in the presence of (a) an inert solvent, (b) a solvent without a β-hydrogen, or a combination thereof, and the concentration of the transition metal compound of formula M¹ₐ(P)ₙR (such as M¹ₐ(CO)ₙR) in the solvent is greater than about 3.1 g/100 mL.

In one embodiment of the sixth aspect, step (a) is conducted in in the presence of (a) an inert solvent, (b) a solvent without a β-hydrogen, or a combination thereof, and the concentration of the transition metal compound of formula M¹ₐ(P)ₙR (such as M¹ₐ(CO)ₙR) in the solvent is greater than about 4 g/100 mL.

In one embodiment of the sixth aspect, step (a) is conducted in in the presence of (a) an inert solvent, (b) a solvent without a β-hydrogen, or a combination thereof, and the concentration of the transition metal compound of formula M¹ₐ(P)ₙR (such as M¹ₐ(CO)ₙR) in the solvent is greater than about 5 g/100 mL.

In one embodiment of the sixth aspect, step (a) is conducted in in the presence of (a) an inert solvent, (b) a solvent without a β-hydrogen, or a combination thereof, and the concentration of the transition metal compound of formula M¹ₐ(P)ₙR (such as M¹ₐ(CO)ₙR) in the solvent is from about 3.5 mg/100 mL to about 50 mg/100 mL.

In one embodiment of the sixth aspect, step (a) is conducted in in the presence of (a) an inert solvent, (b) a solvent without a β-hydrogen, or a combination thereof, and the concentration of the transition metal compound of formula M¹ₐ(P)ₙR (such as M¹ₐ(CO)ₙR) in the solvent is about 3.5 mg/100 mL, about 4 mg/100 mL, about 5 mg/100 mL, about 7.5 mg/100 mL, about 10 mg/100 mL, about 15 mg/100 mL, about 20 mg/100 mL, about 25 mg/100 mL, about 30 mg/100 mL, about 35 mg/100 mL, about 40 mg/100 mL, about 45 mg/100 mL or about 50 mg/100 mL.

In one embodiment of the sixth aspect, step (a) is conducted in in the absence of a solvent (i.e., in the solid state).

In certain embodiments of the sixth aspect, the process further comprises

(c) hydrogenating the product of step (a) or step (b) to form a metal hydride; and

(d) optionally isolating the metal hydride.

In another embodiment of the sixth aspect, the present invention relates to a process for preparing a hydrogen storage material, the process comprising

(a)
(i) thermally and/or photochemically decomposing a transition metal compound of formula M¹ₐ(P)ₙR (such as M¹ₐ(CO)ₙR) optionally in the presence of (a) an inert solvent, (b) a solvent without a β-hydrogen, or a combination thereof, and, optionally, in the presence of hydrogen;
(ii) optionally precipitating the product of step (i) if a precipitate does not form in step (i);

b) optionally isolating the product of step (a); and

(c) hydrogenating the product of step (a) or step (b), in a solvent selected from supercritical Xe, supercritical krypton, supercritical methane, supercritical CO₂, or a combination thereof;

wherein

M¹ is selected from titanium, vanadium, chromium, manganese, iron, cobalt, nickel and copper (preferably manganese);

P is a π-acidic ligand (e.g., CO);

R is absent, hydrogen, substituted or unsubstituted alkyl or substituted or unsubstituted aryl;

a is 1 or 2; and

n is 1, 2, 3, 4, 5, 6, 7, 8, 9, or 10;

wherein the hydrogenated product is a material capable of absorbing H₂ via a Kubas interaction.

In one embodiment, steps (a), (b) if performed, and (c) are conducted in a solvent selected from supercritical Xe, supercritical krypton, supercritical methane, supercritical CO₂, or a combination thereof.

In another embodiment, steps (a), (b) if performed, and (c) are performed in one reaction vessel.

In another embodiment, step (c) is performed without isolating the product of step (a).

In one embodiment of the sixth aspect, M¹ is manganese and the manganese has an oxidation state of from 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3).

In one embodiment of the sixth aspect, the hydrogenated material further comprises one or more additional metals (i.e., one or more additional metals other than M¹).

In one embodiment of the sixth aspect, the one or more additional metals are selected from niobium, molybdenum, technetium, ruthenium, rhodium, palladium, silver, iron, zirconium, zinc, gallium, cadmium, hafnium, tantalum, tungsten, rhenium, osmium, iridium, platinum, gold, mercury, and any combination thereof.

In certain embodiments of the sixth aspect, the hydrogenated material comprises MnHₓ (optionally further comprising residual hydrocarbon and/or solvent) where x is 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of reversibly storing more than two H₂ molecules per Mn.

In certain embodiments of the sixth aspect, M¹ is manganese, and the manganese in the hydrogenated material comprises Mn(I) and Mn(II).

In certain embodiments of the sixth aspect, M¹ is manganese, and the manganese in the hydrogenated material comprises Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the sixth aspect, M¹ is manganese, and the manganese in the hydrogenated material comprises Mn(0), Mn(I) and Mn(II).

In certain embodiments of the sixth aspect, M¹ is manganese, and the manganese in the hydrogenated material comprises Mn(0), Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the sixth aspect, the hydrogenated material is a bulk solid.

In certain embodiments of the sixth aspect, the hydrogenated material is stable at room temperature.

In certain embodiments of the sixth aspect, the hydrogenated material is stable at room temperature as a bulk solid.

The present invention also relates to a hydrogen storage material prepared by a process according to any one of the embodiments of the aspect described herein.

The present invention also relates to a metal hydride (hydrogenated precipitate) prepared by a process according to any one of the embodiments of the aspect described herein.

In a seventh aspect the present invention relates to a compound selected from

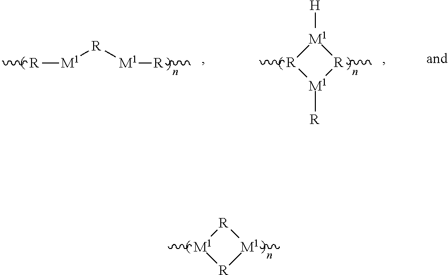

wherein

each M¹ is, independently, selected from titanium, vanadium, chromium, manganese, iron, cobalt, nickel and copper (e.g., manganese);

each R is independently a substituted or unsubstituted alkyl or substituted or unsubstituted aryl group that does not contain a β-hydrogen substituent and is bound to M¹ via a metal-carbon sigma bond not a 3-center 2-electron bond;

and each n is, independently, 1-1000 (e.g., 1-100, 1-50, 1-25, 1-20, 1-10, 3-100, 3-50, 3-25, or 3-20).

In one embodiment of the seventh aspect, each alkyl group is independently a silylated alkyl group.

In one embodiment of the seventh aspect, each substituted or unsubstituted alkyl group is independently selected from mesityl, neopentyl and trimethylsilylmethyl, and any combination thereof.

In one embodiment of the seventh aspect, the present invention relates to a compound selected from

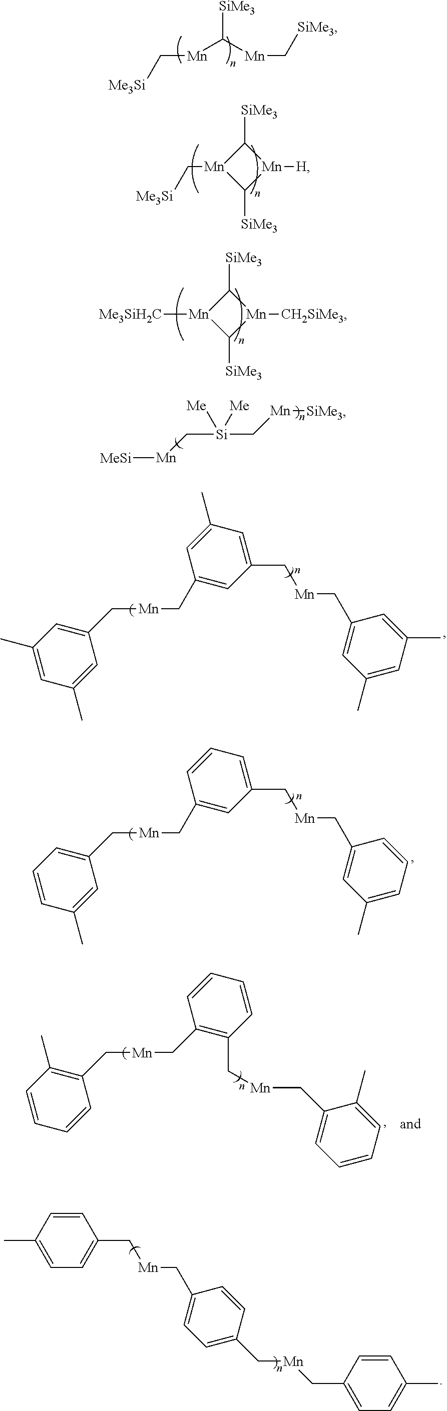

wherein each n is, independently, 1-1000 (e.g., 1-100, 1-50, 1-25, 1-20, 1-10, 3-100, 3-50, 3-25, or 3-20).

In one embodiment of the seventh aspect, the compound is stable at room temperature.

In one embodiment of the seventh aspect, the compound is a bulk solid.

In one embodiment of the seventh aspect, the compound is stable at room temperature as a bulk solid.

In one embodiment of the seventh aspect, the compound, when hydrogenated, is capable of absorbing H₂ via a Kubas interaction.

In one embodiment of the seventh aspect, the compound, when hydrogenated, is capable of absorbing H₂ via a Kubas interaction and physisorption.

In one embodiment of the seventh aspect, the compound, when hydrogenated, is capable of absorbing H₂ (via a Kubas interaction and/or physisorption) to a level of at least about 2 wt %, at least about 4 wt %, at least about 8 wt %, at least about 10 wt %, at least about 10.5 wt % or at least about 12 wt %.

In one embodiment of the seventh aspect, the compound, when hydrogenated, is capable of absorbing at least one H₂ via a Kubas interaction.

In one embodiment of the seventh aspect, the compound, when hydrogenated, is capable of absorbing at least two H₂ via a Kubas interaction.

In one embodiment of the seventh aspect, the compound, when hydrogenated, is capable of absorbing at least three H₂ via a Kubas interaction.

In one embodiment of the seventh aspect, the compound, when hydrogenated, is capable of absorbing at least four H₂ via a Kubas interaction.

In certain embodiments of the seventh aspect, the hydrogenated material comprises MnHₓ (optionally further comprising residual hydrocarbon and/or solvent) where x is 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and is capable of reversibly storing more than two H₂ molecules per Mn.

In certain embodiments of the seventh aspect, M¹ is manganese, and the manganese in the hydrogenated material comprises Mn(I) and Mn(II).

In certain embodiments of the seventh aspect, M¹ is manganese, and the manganese in the hydrogenated material comprises Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In certain embodiments of the seventh aspect, M¹ is manganese, and the manganese in the hydrogenated material comprises Mn(0), Mn(I) and Mn(II).

In certain embodiments of the seventh aspect, M¹ is manganese, and the manganese in the hydrogenated material comprises Mn(0), Mn(I) and Mn(II), the Mn is in an oxidation state between 0.2 to 1.5, such as 0.5 to 1.5 or 1.0 to 1.5 (e.g., 1.0 to 1.4, 1.0 to 1.3, 1.0 to 1.2, 1.1 to 1.4, 1.1 to 1.3, 1.1 to 1.2, 1.2 to 1.4 or 1.2 to 1.3) and the hydrogenated material is capable of absorbing H₂ by a Kubas interaction and/or physisorption to a level of at least about 2 wt %, at least about 4 wt %, at least about 8 wt %, at least about 10 wt %, at least about 10.5 wt % or at least about 12 wt %.

In an eighth aspect, the present invention relates to a process for preparing a metal hydride comprising:

(i) heating an alkyl or aryl transition metal compound (or a combination thereof) in a supercritical solvent (e.g., supercritical Xe, supercritical Kr, supercritical methane, supercritical CO₂, or any combination thereof) in the absence of hydrogen to form a precipitate;

(ii) optionally isolating the precipitate;

(iii) hydrogenating the precipitate; and

(iv) optionally isolating the hydrogenated precipitate.

In one embodiment, the alkyl or aryl transition metal compound has the formula M¹R, M¹R₂, M¹R₃ or M¹R₄ (or a combination thereof), wherein:

M¹ is a transition metal; and

each R group is, independently, selected from alkyl, silylated alkyl, alkenyl, arylalkyl, heteroaryl and aryl. In a preferred embodiment, R is silylated alkyl or aryl.

In one embodiment of the eighth aspect, R does not contain a β-hydrogen substituent (e.g., an organic alkyl group without a β-hydrogen substituent, such as mesityl, neopentyl, trimethylsilylmethyl or benzyl). The starting alkyl or aryl transition metal compound may be monomeric, dimeric, trimeric, tetrameric or polymeric.

In one embodiment of the eighth aspect, M¹ is selected from titanium, vanadium, chromium, manganese, iron, cobalt, nickel and copper, and combinations thereof. In another embodiment of the eighth aspect, M¹ is selected from titanium, vanadium, chromium, manganese, iron, cobalt, and nickel, and combinations thereof. In yet another embodiment of the eighth aspect, M¹ is selected from vanadium, manganese and chromium, and combinations thereof. In yet another embodiment of the eighth aspect, M¹ is manganese

In one embodiment of the eighth aspect, the product of step (i) contains greater than about 10% by weight, such as greater than about 20%, greater than about 30%, greater than about 40% or greater than about 50% or greater than about 60% by weight of residual hydrocarbon. In another embodiment, the product of step (i) contains less than about 60% by weight, such as less than about 50%, less than about 40%, less than about 30%, less than about 20% or less than about 10% by weight of residual hydrocarbon.

In one embodiment of the eighth aspect, step (i) is conducted at a temperature of from about 5° C. to about 250° C., such as from about 50° C. to about 200° C., from about 75° C. to about 150° C., from about 80° C. to about 120° C., from about 90° C. to about 110° C. or from about 95° C. to about 105° C. In one embodiment, step (i) is conducted at about 100° C.

In one embodiment of the eighth aspect, step (i) is conducted for a period of time between about 12 hours and about 72 hours, for example, between about 24 hours and about 60 hours, such as for about 24 hours or for about 48 hours.

In one embodiment of the eighth aspect, step (i) is conducted at a temperature of from about 100° C. for a period of about 48 hours.

In one embodiment of the eighth aspect, step (i) is a solution prior to formation of the desired precipitate.

In one embodiment of the eighth aspect, step (ii) comprises filtering the product of step (i). In another embodiment, step (ii) comprises filtering the product of step (i) followed by drying the resulting solid (e.g., under vacuum, at a temperature of between about 50° C. and 200° C., such as between about 100° C. and 150° C., for example, at about 100° C., optionally, for a period of time between about 1 and about 10 hours, such as between about 2 and 6 hours, for example, about 4 hours). In one embodiment, step (ii) comprises filtering the product of step (i) followed by drying the resulting solid in vacuo at a temperature of about 100° C. for about four hours.

In one embodiment of the eighth aspect, the hydrogenation in step (iii) is conducted at a hydrogen pressure of between about 1 bar and about 200 bar, such as between about 25 bar and about 150 bar, about 50 bar and about 125 bar, about 50 bar and about 100 bar, or about 60 bar to about 80 bar. In additional embodiments, the hydrogenation in step (iii) is conducted at a hydrogen pressure of about 1 bar, about 5 bar, about 10 bar, about 15 bar, about 20 bar, about 25 bar, about 30 bar, about 40 bar, about 50 bar, about 60 bar, about 70 bar, about 80 bar, about 90 bar, or about 100 bar. In one embodiment, the hydrogenation in step (iii) is conducted at a hydrogen pressure of about 70 bar.

In one embodiment of the eighth aspect, step (iii) is conducted at a temperature of from about 10° C. to about 200° C., such as from about 10° C. to about 100° C., from about 15° C. to about 50° C., from about 20° C. to about 40° C., from about 20° C. to about 30° C. In one embodiment, step (iii) is conducted at about 25° C. In one embodiment step (iii) is conducted at room temperature. In one embodiment step (iii) is conducted without heating or cooling.

In one embodiment of the eighth aspect, step (iii) is conducted for a period of time between about 12 hours and about 72 hours, for example, between about 24 hours and about 60 hours, such as for about 48 hours. In another embodiment, step (iii) is conducted for a period of time between about 1 day and about 7 days, e.g., for about 2 days, about 3 days, about 4 days, about 5 days, about 6 days or about 7 days.

In one embodiment of the eighth aspect, step (iii) is conducted at a temperature of about 25° C. and a hydrogen pressure of about 70 bar for about 48 hours.

In one embodiment of the eighth aspect, step (iii) is conducted in the absence of solvent. In another embodiment step (iii) is conducted in a supercritical solvent (e.g., supercritical Xe, supercritical Kr, supercritical methane, supercritical CO₂, or any combination thereof.

In one embodiment of the eighth aspect, the process comprises step (ii) (i.e., step (ii) is not optional and forms part of the process). In another embodiment of the eighth aspect, the process comprises step (iv) (i.e., step (iv) is not optional and forms part of the process). In a preferred embodiment of the eighth aspect, the process comprises steps (i)-(iv) (i.e., steps (ii) and (iv) are not optional and form part of the process).

In another embodiment of the eighth aspect, the process further comprises (v), subjecting the product of step (iii) (or step (iv) if performed) to one or more (such as about 5 or more, about 10 or more, about 20 or more, about 30 or more, about 40 or more or about 50 or more) hydrogen adsorption-desorption cycles.

In one embodiment of the eighth aspect in step (v), hydrogen adsorption-desorption cycles may be conducted at a hydrogen pressure of between about 1 bar and about 250 bar, between about 1 bar and about 200 bar, between about 50 bar and about 170 bar, between about 100 bar and about 150 bar or between about 120 bar and about 150 bar. In additional embodiment of the eighth aspect, the hydrogenation in step (v) is conducted at a hydrogen pressure of about 1 bar, about 5 bar, about 10 bar, about 15 bar, about 20 bar, about 25 bar, about 30 bar, about 40 bar, about 50 bar, about 60 bar, about 70 bar, about 80 bar, about 90 bar, about 100 bar, about 125 bar or about 150 bar.

In additional embodiments, any of the precipitates and/or hydrogenated precipitates (metal hydrides) disclosed in any of the embodiments of any of the aspects described herein is free or substantially free of metal ions other than titanium, vanadium, chromium, iron, cobalt, nickel, and copper.

In additional embodiments, any of the precipitates and/or hydrogenated precipitates (metal hydrides) disclosed in any of the embodiments of any of the aspects described herein is a solid, a gel or a pellet, and, optionally, is substantially amorphous.

In additional embodiments, any of the hydrogenated precipitates (metal hydrides) disclosed in any of the embodiments of any of the aspects described herein is used for hydrogen storage.

In additional embodiments, for any of the hydrogenated precipitates (metal hydrides) disclosed in any of the embodiments of any of the aspects described herein, hydrogenation and/or dehydrogenation of the hydrogenated precipitate is thermodynamically neutral.

The present invention also relates to a composition comprising one or more hydrogenated precipitate(s) (metal hydrides) according to any of the embodiments of any of the aspects described herein.

The present invention also relates to metal hydride storage material comprising one or more hydrogenated precipitate (metal hydride) disclosed in any of the embodiments of any of the aspects described herein.

The present invention also relates to a method of storing hydrogen comprising:

(i) providing a precipitate according to any of the embodiments of any of the aspects described herein;

(ii) hydrogenating the precipitates to form a hydrogenated precipitate;

(iii) adding hydrogen to the hydrogenated precipitate; and

(iv) allowing the hydrogen to coordinate to the hydrogenated precipitate; optionally wherein the hydrogen is stored in a storage system, such that the method comprises

(i) providing a precipitate according to any of the embodiments of any of the aspects described herein in the storage system;

(ii) hydrogenating the precipitate to form a hydrogenated precipitate;

(iii) adding hydrogen to the hydrogenated precipitate in the storage system; and

(iv) allowing the hydrogen to coordinate to the hydrogenated precipitate in the storage system

The present invention also relates to a method of storing hydrogen comprising:
(i) providing a hydrogenated precipitate (metal hydride) according to any of the embodiments of any of the aspects described herein;
(ii) adding hydrogen to the metal hydride; and
(iii) allowing the hydrogen to coordinate to the metal hydride;

optionally wherein the hydrogen is stored in a storage system, such that the method comprises

(i) providing a hydrogenated precipitate (metal hydride) according to any of the embodiments of any of the aspects described herein in the storage system;

(ii) adding hydrogen to the hydrogenated precipitate in the storage system; and

(iii) allowing the hydrogen to coordinate to the hydrogenated precipitate in the storage system.

In one embodiment, the storage methods further comprise releasing the hydrogen from the metal hydride.

In one embodiment, the hydrogen is released from the hydrogenated precipitate (metal hydride) by reducing the pressure of the hydrogen in the storage system, increasing the temperature of the storage system, or a combination thereof.

In one embodiment, the adsorption of hydrogen to the hydrogenated precipitate (metal hydride) and/or desorption of hydrogen from the metal hydride is thermodynamically neutral.

The present invention also relates to a hydrogen storage system comprising a storage system and a hydrogenated precipitate (metal hydride) according to any of the embodiments of any of the aspects described herein within the storage system.

The present invention also relates to a battery or fuel cell comprising a hydrogenated precipitate (metal hydride) according to any of the embodiments of any of the aspects described herein.

The present invention also relates to a storage system for a gas selected from hydrogen, methane and compressed natural gas comprising a storage system and a hydrogenated precipitate (metal hydride) according to any of the embodiments of any of the aspects described herein within the storage system.

The present invention also relates to a storage system for producing electricity using a fuel-cell or heat using an oxidant, comprising a storage system and a hydrogenated precipitate (metal hydride) according to any of the embodiments of any of the aspects described herein within the storage system.

In one embodiment, any of the starting alkyl and/or aryl transition metal compounds described herein may be monomeric, dimeric, trimeric, tetrameric or polymeric.

In one embodiment of any of the aspects described herein, M¹ is selected from titanium, vanadium, chromium, manganese, iron, cobalt, nickel and copper, and combinations thereof. In one embodiment of any of the aspects described herein, M¹ is selected from titanium, vanadium, chromium, manganese, iron, cobalt, and nickel, and combinations thereof. In yet another embodiment of any of the aspects described herein, M¹ is selected from vanadium, manganese and chromium, and combinations thereof. In yet another embodiment of any of the aspects described herein, M¹ is selected from manganese.

In another embodiment, any of the hydrogenated precipitates according to any of the embodiments of any of the aspects described herein described is subjected to one or more (such as about 5 or more, about 10 or more, about 20 or more, about 30 or more, about 40 or more or about 50 or more) hydrogen adsorption-desorption cycles.

In one embodiment, hydrogen adsorption-desorption cycles may be conducted at a hydrogen pressure of between about 1 bar and about 250 bar, between about 1 bar and about 200 bar, between about 50 bar and about 170 bar, between about 100 bar and about 150 bar or between about 120 bar and about 150 bar. In additional embodiments, the hydrogenation in step (v) is conducted at a hydrogen pressure of about 1 bar, about 5 bar, about 10 bar, about 15 bar, about 20 bar, about 25 bar, about 30 bar, about 40 bar, about 50 bar, about 60 bar, about 70 bar, about 80 bar, about 90 bar, about 100 bar, about 125 bar or about 150 bar.

In one embodiment, hydrogenation and/or dehydrogenation of any of the hydrogenated precipitates according to any of the embodiments of any of the aspects described herein is thermodynamically neutral, such as when averaged over the bulk sample. For example, the net enthalpy changes associated with either the process of hydrogen adsorption and/or the process of hydrogen desorption, such as when averaged over the bulk sample, are close to 0 kJ mol⁻¹ H₂.

For example, in one embodiment, any of the hydrogenated precipitates according to any of the embodiments of any of the aspects described herein adsorb and/or desorb hydrogen at an absolute value of about 0 to about ±3 kJ mol⁻¹ H₂, such as at about 0 to about ±2.5 kJ mol⁻¹ H₂, about 0 to about ±2 kJ mol⁻¹ H₂, about 0 to about ±1.5 kJ mol⁻¹ H₂, about 0 to about ±1 kJ mol⁻¹ H₂, about 0 to about ±0.5 kJ mol⁻¹ H₂ or about 0 to about ±0.25 kJ mol⁻¹ H₂.

In another embodiment, any of the hydrogenated precipitates according to any of the embodiments of any of the aspects described herein adsorb and/or desorb hydrogen at an absolute value of about ±0.5 to about ±3 LI mol⁻¹ H₂, such as at about ±0.5 to about ±2.5 kJ mol⁻¹ H₂, about ±0.5 to about ±2 kJ mol⁻¹ H₂, about ±0.5 to about ±1.5 kJ mol⁻¹ H₂, about ±0.5 to about ±1 kJ mol⁻¹ H₂, or about ±0.5 to about ±0.75 kJ mol⁻¹ H₂.

In another embodiment, any of the hydrogenated precipitates according to any of the embodiments of any of the aspects described herein adsorb and/or desorb hydrogen at an absolute value of about ±1 to about ±3 kJ mol⁻¹ H₂, such as at about ±1 to about ±2.5 kJ mol⁻¹ H₂, about ±1 to about ±2 kJ mol⁻¹ H₂, about ±1 to about ±1.5 kJ mol⁻¹ H₂, or about ±1 to about ±1.25 kJ mol⁻¹ H₂.

In another embodiment, any of the hydrogenated precipitates according to any of the embodiments of any of the aspects described herein adsorb and/or desorb hydrogen at an absolute value of about ±1.5 to about ±3 kJ mol⁻¹ H₂, such as at about ±1.5 to about ±2.5 kJ mol⁻¹ H₂, about ±1.5 to about ±2 kJ mol⁻¹ H₂, or about ±1.5 to about ±1.75 kJ mol⁻¹ H₂.

In another embodiment, any of the hydrogenated precipitates according to any of the embodiments of any of the aspects described herein adsorb and/or desorb hydrogen at an absolute value of less than about ±4 kJ mol⁻¹ H₂, such as less than about ±3.75 kJ mol⁻¹ H₂, less than about ±3.5 kJ mol⁻¹ H₂, less than about ±3.25 kJ mol⁻¹ H₂, less than about ±3 kJ mol⁻¹ H₂, less than about ±2.75 kJ mol⁻¹ H₂, less than about ±2.5 kJ mol⁻¹ H₂, less than about ±2.25 kJ mol⁻¹ H₂, less than about ±2 LI mol⁻¹ H₂, less than about ±1.75 kJ mol⁻¹ H₂, less than about ±1.5 kJ mol⁻¹ H₂, less than about ±1.25 kJ mol⁻¹ H₂, less than about ±1 kJ mol⁻¹ H₂, less than about ±0.75 kJ mol⁻¹ H₂, less than about ±0.5 LI mol⁻¹ H₂, less than about ±0.25 kJ mol⁻¹ H₂ or less than about ±0.1 kJ mol⁻¹ H₂.

In another embodiment, any of the hydrogenated precipitates according to any of the embodiments of any of the aspects described herein adsorb and/or desorb hydrogen at an absolute value of about ±3 kJ mol⁻¹ H₂, such as at about ±2.9 kJ mol⁻¹ H₂, about ±2.8 kJ mol⁻¹ H₂, about ±2.7 kJ mol⁻¹ H₂, about ±2.6 kJ mol⁻¹ H₂, about ±2.5 kJ mol⁻¹ H₂, about ±2.4 kJ mol⁻¹ H₂, about ±2.3 kJ mol⁻¹ H₂, about ±2.2 kJ mol⁻¹ H₂, about ±2.1 kJ mol⁻¹ H₂, about ±2 kJ mol⁻¹ H₂, about ±1.9 kJ mol⁻¹ H₂, about ±1.8 kJ mol⁻¹ H₂, about ±1.7 kJ mol⁻¹ H₂, about ±1.6 kJ mol⁻¹ H₂, about ±1.5 kJ mol⁻¹ H₂, about ±1.4 kJ mol⁻¹ H₂, about ±1.3 kJ mol⁻¹ H₂, about ±1.2 kJ mol⁻¹ H₂, about ±1.1 kJ mol⁻¹ H₂, about ±1 kJ mol⁻¹ H₂, about ±0.9 kJ mol⁻¹ H₂, about ±0.8 kJ mol⁻¹ H₂, about ±0.7 kJ mol⁻¹ H₂, about ±0.6 kJ mol⁻¹ H₂, about ±0.5 kJ mol⁻¹ H₂, about ±0.4 kJ mol⁻¹ H₂, about ±0.3 kJ mol⁻¹ H₂, about ±0.2 kJ mol⁻¹ H₂, or about ±0.1 kJ mol⁻¹ H₂.

In one embodiment of any of the hydrogenated precipitates according to any of the embodiments of any of the aspects described herein, the hydrogenated precipitate is in the bulk phase. In one embodiment of of any of the hydrogenated precipitate according to any of the embodiments of any of the aspects described herein, the hydrogenated precipitate is polymeric, e.g., polymeric in the bulk phase.

In one embodiment, any of the hydrogenated precipitates according to any of the embodiments of any of the aspects described herein are mesoporous (e.g., have a pore diameter between about 0.5 and about 50 nm or between about 2 and about 50 nm). In another embodiment, any of the hydrogenated precipitates according to any of the embodiments of any of the aspects described herein are microporous (e.g., have a pore diameter less than about 2 nm, such as less than about 1 nm). In one embodiment, any of the hydrogenated precipitates described herein have a pore diameter of about 2 nm.

In one embodiment, any of the hydrogenated precipitates according to any of the embodiments of any of the aspects described herein have a porosity of between about 5 and about 80%, such as between about 5 and about 70%, between about 5 and about 60%, between about 5 and about 50%, between about 5 and about 40%, between about 5 and about 30% or between about 5 and about 20%.

In one embodiment, any of the hydrogenated precipitates according to any of the embodiments of any of the aspects described herein are amorphous or substantially amorphous (e.g., with little (e.g., nanoscopic order) or no long range order in the position of the atoms in the hydride structure). In one embodiment, any of the hydrogenated precipitates according to any of the embodiments of any of the aspects described herein contain less than about 20% crystallinity, such as less than about 10%, less than about 5%, less than about 2.5%, less than about 1%, less than about 0.5% crystallinity, or less than about 0.1% crystallinity as measured, for example, by X-ray diffraction using a Cu Kα radiation (40 kV, 40 mA) source.

In one embodiment, any of the hydrogenated precipitates according to any of the embodiments of any of the aspects described herein is compacted into a pellet form, optionally with a binder and/or lubricant (e.g., amorphous carbon, paraffin, mineral oil, or a polymer such as cellulose or polypropylene) or other material (e.g., an inorganic compound such as TiO₂, a metal or a metal alloy such as Ni to facilitate the pelletization process). The binder, lubricant and/or other material may be incorporated at this stage to minimize the effects of poisoning, hydrolysis or other potentially adverse reaction induced by contaminants in the hydrogen supply to the material in its final form. Additional additives (e.g., porous carbons, metal organic frameworks (MOFs) and covalent organic frameworks (COFs)) may also be added to accelerate the rate at which the hydrogen is adsorbed and desorbed by the hydrogenated precipitates described herein. In one embodiment, the hydrogenated precipitate is deposited in the macropores of a honeycomb-structured support.

The storage system (e.g., storage tank) tank may comprise one or more openings in a wall of the storage system. Fluids, such as hydrogen gas, can pass into and out of the storage tank through the one or more openings. The system may further comprise one or more valves which control the passage of fluids through the one or more openings. The one or more valves can be used to release pressure inside the storage tank by opening said one or more valves and allowing fluids to pass out of the storage tank through the one or more openings. The system may also further comprise a compressor (e.g., a gas compressor) for adding hydrogen into the storage system.

In additional embodiments, the method of storing hydrogen further comprises releasing the hydrogen from the hydrogenated precipitate (e.g., a hydrogenated precipitate in a storage system). In one embodiment, the hydrogen is released from the hydrogenated precipitate by reducing the pressure of the hydrogen in the storage system. In one embodiment, the hydrogen is released from the hydrogenated precipitate by changing (e.g., increasing) the temperature of the storage system.

Yet another embodiment of the present invention relates to a hydrogen storage system comprising a storage system and a hydrogenated precipitate within the storage system, wherein the hydrogenated precipitate is encompassed by any of the embodiments in any of the aspects described herein.

The hydrogenated precipitates described herein may be useful in other applications, such as, but not limited to, methane adsorption, compressed natural gas storage, propellants, battery technologies, fuel cells, sorbents, olefin polymerization catalysts and sensors. The hydrogenated precipitates may also be useful in other applications, such as, but not limited to, propelling electric and/or hybrid vehicles, and storing electricity while connected to the electrical grid. In one embodiment, the present invention relates to a storage system (which can be of any size and be stationary or mobile) for producing energy in conjunction with a fuel-cell, the storage system comprising a hydrogenated precipitate according to any embodiment of any aspect described herein within the storage system.

A propellant is a material that is used to move or propel an object, such as a jet or rocket. A propellant may comprise a fuel and an oxidizer. The fuel may be, for example, gasoline, jet fuel or rocket fuel. When the hydrogenated precipitates of the present invention are used in a propellant, the propellant further comprises hydrogen. The hydrogen may coordinate to a metal center present in the hydrogenated precipitate. In one embodiment, the hydrogen is in liquid form. In a preferred embodiment, the propellant further comprises an oxidizer, for example, liquid oxygen. In one embodiment, the propellant is used to propel a jet or a rocket. In another embodiment, it is used in conjunction with an oxidixer in a flame-producing device such as, e.g., a welding torch.

A battery comprises one or more electrochemical cells, which convert stored chemical energy into electrical energy. The hydrogenated precipitates of the present invention may be used to coordinate to and store a compound in a battery. In a preferred embodiment, the compound that is stored is hydrogen. In one embodiment, the battery converts energy stored in the hydrogen into electrical energy. In one embodiment, the hydrogenated precipitates of the present invention are used in conjunction with a fuel cell for generating electricity.

A sorbent is a material that is used to absorb a liquid or a gas. The hydrogenated precipitates of the present invention may be used as a sorbent to absorb a liquid or a gas. For example, the hydrogenated precipitates of the present invention may be used to absorb hydrogen. In one embodiment, the hydrogen is is liquid form. In another embodiment, the hydrogen is in the form of a gas.

Another embodiment is a catalyst system for polymerization of olefins comprising a hydrogenated precipitate of the present invention. The catalyst system may further comprise a support.

Yet another embodiment is a process comprising polymerizing or copolymerizing olefins (e.g., ethylene, propylene) carried out in the presence of a catalyst system of the present invention.

A sensor is used to detect a substance or to measure a physical quantity. The sensor gives a signal that the substance has been detected or gives a signal representing the measurement of the physical quantity. The signal can be read by an observer or by an instrument.

The hydrogenated precipitates described herein may be used in a sensor. For example, the hydrogenated precipitates described herein may be used to detect hydrogen, e.g., in a system. In one embodiment, the hydrogenated precipitates described herein measure the amount of hydrogen that is present in a system. In one embodiment, the hydrogen is in liquid form. In another embodiment, the hydrogen is in the form of a gas.

The hydrogenated precipitates described herein may be used for propelling electric and/or hybrid vehicles or for storing electricity while connected to the electrical grid.

In another aspect, the present invention relates to a battery or fuel cell comprising a hydrogenated precipitate according to any embodiment described herein.

In another aspect, the present invention relates to a storage system for producing electricity using a fuel-cell or heat using an oxidant, comprising a storage system and a hydrogenated precipitate according to any embodiment described herein.

In another aspect, the present invention relates to a storage system for a gas selected from hydrogen, methane and compressed natural gas comprising a storage system and a hydrogenated precipitate according to any embodiment described herein.

In another aspect, the present invention relates to a storage system for producing electricity using a fuel-cell or heat using an oxidant, comprising a storage system and a hydrogenated precipitate according to any embodiment described herein within the storage system.

In another aspect, the present invention relates to a storage system comprising a hydrogen storage material (metal hydride) prepared according to any embodiment described herein, wherein the hydrogen storage material (metal hydride) is prepared directly in the storage system. In one embodiment, the hydrogen storage material (metal hydride) is prepared according to any embodiment described herein without isolation of any intermediate compound(s).

In another aspect, the present invention relates to a monolith (e.g., a porous monolith) comprising a hydrogen storage material (e.g., a metal hydride) prepared according to any embodiment of any of the processes described herein.

### BRIEF DESCRIPTION OF THE DRAWINGS

FIG. 1 depicts an embodiment of a storage system useful in the present invention.

FIG. 2 depicts an embodiment of the storage system attached to a hydrogen fuel cell.

FIG. 3 depicts an Infra Red spectrum of bis (trimethylsilylmethyl) manganese.

FIG. 4 depicts an Infra Red spectrum of a product of Example 1.

FIG. 5 depicts hydrogen adsorption/desorption measurements of the product of Example 1.

FIG. 6 depicts an Infra Red spectrum of a product of Example 2.

FIG. 7 depicts hydrogen adsorption/desorption measurements of the product of Example 2.

FIG. 8 depicts an Infra Red spectrum of a product of Example 3.

FIG. 9 depicts hydrogen adsorption/desorption measurements of the product of Example 3.

### DETAILED DESCRIPTION OF THE INVENTION

### Definitions

Unless defined otherwise, all technical and scientific terms used herein generally have the same meaning as commonly understood by one of ordinary skill in the art to which this invention belongs.

The term “comprising” is open ended and, in connection with a composition, refers to the elements recited. The term “comprising” as used in connection with the compositions described herein can alternatively cover compositions “consisting essentially of” or “consisting of” the recited components.

The term “coordinate” as used here is not limited to a specific type of interaction between a metal center and hydrogen. For example, in one embodiment, the interaction between a metal center and hydrogen is a Kubas interaction.

The term “Kubas interaction” refers to hydrogen bound in a non-dissociative manner as a dihydrogen molecule to a transition metal center. In a Kubas interaction, free d-electrons of a metal centre interact with hydrogen. Specifically, where the metal centre has a low coordination number, the dihydrogen shares both of its σ-bonding electrons with the metal centre, and the metal centre back donates electrons by overlap of its π symmetry d-orbital with the empty antibonding σ* empty orbital of the dihydrogen. This results in a lengthening of the H—H bond (without rupture) and a shift to a lower wavenumber for the H—H resonance (see, e.g. J. Am. Chem. Soc., 119, 9179-9190, 1997).

Without wishing to be bound by theory, the inventor theorizes that one or more (such as 2 or more, such as 3, 4 or 5) H₂ molecules interact with the metal centers by Kubas interactions to form metal hydrides of the formula MHₓ (optionally further comprising residual hydrocarbon and/or solvent) in which x can be approximately an even number, e.g., about 4, about 6, about 8, about 10 or about 12. However, bimolecular and/or free radical processes may also occur leading to metal hydrides of the formula MHₓ in which x can approximately an odd number, e.g., about 3, about 5, about 7, about 9, about 11 or about 13. Additionally, mixed metal hydrides, in which variable x is a non integer may also be formed by continuous (not stepwise) adsorption.

The term “substantially free” as used herein means containing less than about 2 wt %, such as less than about 1 wt %, less than about 0.5 wt %, less than about 0.1 wt %, less than about 0.05 wt %, less than about 0.01 wt %, less than about 0.005 wt % or less than about 0.001 wt % of a specified element or compound.

In one embodiment, the term “residue” refers to any carbon containing group that may be present in a precipitate or hydrogenated precipitate described herein. For example, the residue may be a solvent used in the formation of the precipitate or hydrogenated precipitate that has not been fully removed during the synthesis process. Another example of a residue may be a ligand (e.g., trimethylsilylmethyl, mesityl, benzyl or neopentyl) that is not fully removed from the metal center during formation of the precipitate or hydrogenated precipitate. The residue may also be a compound (e.g., a protic compound, such as methanol) that is added to the hydrogenated precipitate in order to increase microporosity of the hydrogenated precipitate structure (e.g., by forming bridging methoxide ligands within the structure), thereby facilitating H₂ moving in and out of the hydrogenated precipitate. The term “residue” may also refer to residual metal halide, such as MgCl₂, ZnCl₂, LiCl, LiI, etc.

As used herein, in one embodiment the term “thermodynamically neutral” refers to the net enthalpy changes associated with either the process of hydrogen adsorption and/or the process of hydrogen desprotion when averaged over the whole metal hydride sample. For example, the net enthalpy changes associated with either the process of hydrogen adsorption and/or the process of hydrogen desprotion, when averaged over the bulk sample, are close to 0 kJ mol⁻¹ H₂. Typically, hydrogen adsorption on a microscopic basis exhibits a range of enthalpies between about −5 and −70 kJ mol⁻¹ H₂. Without wishing being bound to theory, the inventor theorizes that the energy required by external pressure to open up binding sites in the metal hydride is approximately equal and opposite to the exothermic M-H bond forming process, resulting in effective enthalpy buffering and thermodynamic neutrality. Also without being bound to theory, the inventor theorizes that the energy required to open up the hydrogen binding sites in the metal hydrides described herein is provided by the gradually increasing external pressure of the hydrogen, which is roughly equal and opposite in value to the energy involved in hydrogen binding to the metal enters resulting in thermodynamic neutrality, and can be rationalised by the energy required to twist the amorphous structure into a conformation favourable for hydrogen binding. See, e.g., Skipper et al., J. Phys. Chem. C, 116, 19134, 2012.

As used herein, the term “alkyl” refers to a straight or branched chain saturated hydrocarbon moiety. In one embodiment, the alkyl group is a straight chain saturated hydrocarbon. Unless otherwise specified, the “alkyl” or “alkylene” group contains from 1 to 24 carbon atoms. Representative saturated straight chain alkyl groups include, e.g., methyl, ethyl, n-propyl, n-butyl, n-pentyl, and n-hexyl. Representative saturated branched alkyl groups include, e.g., isopropyl, sec-butyl, isobutyl, tert-butyl, neopentyl, and isopentyl. In a preferred embodiment, an “alkyl” group does not contain a β hydrogen substituent.

As used herein, the term “substituted alkyl” refers to an alkyl group as defined above substituted by, for example, one or more heteroatoms, such as, Si, Se, O, N and S.

As used herein, the term “aryl” refers to an aromatic hydrocarbon (mono- or multi-cyclic) having from 6 to 24 carbon atoms (e.g., phenyl, naphthyl), bound to the metal center via a metal-carbon bond.

As used herein, the term “substituted aryl” refers to an aryl group as defined above substituted by, for example, one or more alkyl groups (e.g., methyl), and/or one or more heteroatoms, such as, Si, Se, P, O, N and S.

As used herein, the terms “hydrogenated precipitate” and “metal hydride” may be used interchangeably. The “hydrogenated precipitate” and “metal hydride” are capable of absorbing H₂ via a Kubas interaction.

As used herein, the term π-acidic ligand refers to a ligand that donates electron density into a metal d-orbital from a 2-symmetry bonding orbital between the atoms. PP-acidic ligands are ligands that have a relatively low-lying LUMO that has the appropriate symmetry to interact with a d-orbtal (dxy, dxz, dzy) on the transition metal centre and the resultant molecular orbital formed will have pi-symmetry. Suitable non-limiting examples of π-acidic ligands that may be used herein include, but are not limited to, CO, N₂, CN, O₂, NO⁻, CO₂, olefins, carbenes, isocyanides, isothiocyanates, and any combination thereof. In one embodiment, the π-acidic ligand is CO.

As used herein, the terms “precipitate” and “hydrogen storage material precursor” may be used interchangeably. The “precipitate” or “hydrogen storage material precursor” is hydrogenated to provide the “hydrogenated precipitate” or “metal hydride.”

In one embodiment, the term “inert solvent” refers to a solvent that does not undergo C—H activation with the transition metal (e.g., M¹) center. The term “inert solvent” may also refer to a solvent that does not otherwise complex with the transition metal (e.g., M¹, such as manganese) center.

### Hydrogenated Precipitates

In one embodiment, any of the hydrogenated precipitates described herein has a BET surface area of less than about 5 m²/g, such as less than about 4 m²/g, such as less than about 3 m²/g, less than about 2 m²/g, less than about 1.5 m²/g or less than about 1.0 m²/g, such as about 0.6 m²/g.

In another embodiment, any of the hydrogenated precipitates described herein has a BET surface area of about 2 m²/g or greater, such as about 5 m²/g or greater, about 7.5 m²/g or greater, about 10 m²/g or greater, about 25 m²/g or greater, about 50 m²/g or greater, about 75 m²/g or greater, about 100 m²/g or greater, about 150 m²/g or greater, about 200 m²/g or greater, about 250 m²/g or greater, about 275 m²/g or greater, about 300 m²/g or greater, about 350 m²/g or greater, about 400 m²/g or greater, about 450 m²/g or greater or about 500 m²/g or greater. For example, the metal hydride has a BET surface area of about 377 m²/g or 391 m²/g. In another embodiment, any of the hydrogenated precipitates described herein has a BET surface area of up to about 2000 m²/g, such as 1000-2000 m²/g or 1500-200 m²/g.

In other embodiments, the BET surface area is from about 2 m²/g to about 1000 m²/g, such as from about 10 m²/g to about 750 m²/g, from about 50 m²/g to about 500 m²/g, from about 100 m²/g to about 500 m²/g, from about 250 m²/g to about 500 m²/g, from about 300 m²/g to about 500 m²/g. In one embodiment, the BET surface area is from about 300 m²/g to about 400 m²/g.

In one embodiment, the hydrogenated precipitates described herein are in the form of a gel. In one embodiment, the hydrogenated precipitates described herein are in the form of a solid (e.g., a powder). In one embodiment, any of the hydrogenated precipitates described herein is a bulk solid, for example, a stable bulk solid at room temperature. In one embodiment, the hydrogenated precipitates described herein are polymeric (e.g., polymeric in the bulk phase). In one embodiment, the hydrogenated precipitates described herein are in the form of a pellet.

In one embodiment, any of the hydrogenated precipitates described have a pore diameter of about 2 nm.

In one embodiment, any of the hydrogenated precipitates described herein have a porosity of between about 5 and about 80%, such as between about 5 and about 70%, between about 5 and about 60%, between about 5 and about 50%, between about 5 and about 40%, between about 5 and about 30% or between about 5 and about 20%.

In further embodiments, any of the hydrogenated precipitates described herein exhibit a gravimetric hydrogen absorption at least about 2%, at least about 3%, at least about 4%, at least about 5%, at least about 6%, at least about 7%, at least about 8%, at least about 9%, at least about 10%, at least about 11%, at least about 12%, at least about 13% or at least about 14%, e.g., in an amount up to about 14%, such as from about 2.0% to about 14.0%, from about 8.0% to about 12.0%, or about 3.5%, about 7.0%, about 10.5%, about 14%) based upon 100% total weight of the metal hydride without molecular hydrogen stored in it.

In another embodiment, any of the hydrogenated precipitates described herein are free or substantially free of metal ions (other than titanium, vanadium, chromium, iron, cobalt, nickel and/or copper). In another embodiment, any of the hydrogenated precipitates described herein are free or substantially free of organic residue (e.g., organic ligands or solvents used during the synthesis of the hydrogenated precipitate). In another embodiment, any of the hydrogenated precipitates described herein are free or substantially free of metal ions (other than titanium, vanadium, chromium, iron, cobalt, nickel and/or copper) and free or substantially free of organic residue (e.g., organic ligands or solvents used during the synthesis of the hydrogenated precipitates).

In another embodiment, any of the metal hydrides described herein may contain a transition metal in more than one oxidation state (e.g., M(I)/M(II), M(0)/M(I)/M(II)) wherein M is a metal as described herein.

The hydrogenated precipitates described herein preferably have sufficient microporosity (which may or may not be visible by nitrogen adsorption) to permit H₂ to move in and out of the metal hydride framework to the active binding sites. In one embodiment, the hydrogenated precipitate has sufficient microporosity to permit: (i) H₂ to diffuse in and out of the material and the active binding sites of the metal hydride; (ii) the metal to coordinate with H₂ via, for example, a Kubas interaction; and (iii) absorption of H₂ in an amount of about 2.0% to about 14.0% (based upon 100% total weight of the metal hydride without hydrogen stored in it). The hydrogenated precipitates may be incorporated into a hydrogen storage system as described herein.

In yet another embodiment, any of the hydrogenated precipitates described herein is crystalline. In one embodiment, and without being bound by theory, the H₂ may move through the structure via a shuttle mechanism whereby it binds to the metal on one side and desorbs on the other to penetrate further into the structure, or moves through lammellai between crystalline planes.

In one embodiment, the hydrogenated precipitates described herein are amorphous or substantially amorphous (e.g., with little (e.g., nanoscopic order) or no long range order in the position of the atoms in the hydride structure). In one embodiment, the hydrogenated precipitates described herein contain less than about 20% crystallinity, such as less than about 10%, less than about 5%, less than about 2.5%, less than about 1%, less than about 0.5% or or less than about 0.1% crystallinity, as measured, for example, by X-ray diffraction using a Cu Kα radiation (40 kV, 40 mA) source. Hydrogenated precipitates having closed packed structures are desirable due to their higher volumetric densities, so long as they permit diffusion of H₂ to the metal binding sites within them. Where the closed packed structure of a hydrogenated precipitate does not permit diffusion of H₂ to the metal binding sites, the hydrogenated precipitate preferably does not have a closed packed structure.

In one embodiment, the hydrogenated precipitates described herein are greater than 80% amorphous, such as greater than about 85%, greater than about 90%, greater than about 95%, greater than about 99% or greater than about 99.5% amorphous, as measured, for example, by X-ray diffraction using a Cu Kα radiation (40 kV, 40 mA) source.

In another embodiment, any of the hydrogenated precipitates described herein may contain a minor amount (e.g., up to 0.5 moles total) of an impurity selected from phosphines (e.g., trimethylphosphine), ethers, water, alcohols, amines, olefins, sulfides, nitrides, and combinations thereof. The phosphine (e.g., trimethylphosphine), ether, water, alcohol, amine, olefin (e.g., 1-hexene) sulfide or nitride residues may remain from their use in the synthesis of the metal hydride or may be formed as byproducts during the synthesis. In one embodiment, any of the hydrogenated precipitates of the present invention may contain less than about 10.0 wt %, less than about 9.0 wt %, less than about 9.0 wt %, less than about 7.5 wt %, less than about 5.0 wt %, less than about 4.0 wt %, less than about 3.0 wt %, less than about 2.0 wt %, less than about 1.0 wt %, less than about 0.75 wt %, less than about 0.5 wt %, less than about 0.4 wt %, less than about 0.3 wt %, less than about 0.25 wt %, less than about 0.2 wt %, less than about 0.1 wt %, less than about 0.05 wt %, less than about 0.01 wt %, less than about 0.005 wt % or less than about 0.001 wt % of a phosphine (e.g., trimethylphosphine), ethers (e.g., Et₂O, THF, dioxane), water, alcohol, amine, olefin (e.g., 1-hexene), sulfide or nitride residue, or a combination thereof. In a preferred embodiment, the hydrogenated precipitate is free or substantially free of a phosphine (e.g., trimethylphosphine), ethers, water, alcohol, amine, olefin, sulfide or nitride residue, or a combination thereof. In addition, in embodiments where impurities are found, hydrogenated precipitates may also contain minor amounts (e.g., up to 0.5 moles total) of metal hydroxides (M-OH) and metal ethers (M-O-M) from the hydrolysis of metal alkyl species with residual water contained within the reaction mixture.

In certain embodiments, any of the hydrogenated precipitates contain less than about 10.0 wt % of lithium or magnesium, or a combination thereof. These lithium and magnesium residues may remain from their use in the synthesis of the hydrogenated precipitates. For example, any of the hydrogenated precipitates may contain less than about 9.0 wt %, less than about 8.0 wt %, less than about 7.5 wt %, less than about 5.0 wt %, less than about 4.0 wt %, less than about 3.0 wt %, less than about 2.0 wt %, less than about 1.0 wt %, less than about 0.75 wt %, less than about 0.5 wt %, less than about 0.25 wt %, less than about 0.1 wt % or less than about 0.05 wt %, less than about 0.01 wt %, less than about 0.005 wt %, or less than about 0.001 wt % of lithium or magnesium or a combination thereof. In another embodiment, any of the hydrogenated precipitates contain less than about 0.5 wt % of lithium or magnesium, or a combination thereof. For example, any of the hydrogenated precipitates may contain less than about 0.4 wt %, less than about 0.3 wt %, less than about 0.25 wt %, less than about 0.2 wt %, less than about 0.1 wt %, less than about 0.05 wt %, less than about 0.01 wt %, less than about 0.005 wt % or less than about 0.001 wt % of lithium or magnesium or a combination thereof. In a preferred embodiment, the hydrogenated precipitate is free or substantially free of lithium or magnesium, or a combination thereof.

The hydrogenated precipitates of the present invention may contain halogen. For instance, the hydrogenated precipitates may contain less than about 20.0 wt % of a halogen, such as less than about 10.0 wt % of a halogen (such as Br⁻, Cl⁻, or I⁻). These halogen residues may remain from their use in the synthesis of the hydrogenated precipitate (for instance, from the use of a Grignard reagent). For example, any of the hydrogenated precipitates may contain less than about 9.0 wt %, less than about 8.0 wt %, less than about 7.5 wt %, less than about 5.0 wt %, less than about 4.0 wt %, less than about 3.0 wt %, less than about 2.0 wt %, less than about 1.0 wt %, less than about 0.75 wt %, less than about 0.5 wt %, less than about 0.25 wt %, less than about 0.1 wt % less than about 0.05 wt %, less than about 0.01 wt %, less than about 0.005 wt %, or less than about 0.001 wt % of halogen. In a preferred embodiment, the hydrogenated precipitate is free or substantially free of halogen.

In other embodiments, any of the hydrogen storage materials (metal hydrides, hydrogenated precipitates) described herein further comprise up to about 5% by weight of bound π-acid ligand (e.g., CO, N₂, CN, O₂, NO⁻, CO₂, olefins, carbenes, isocyanides, isothiocyanates, or any combination thereof), such as about 0.1% to about 5% by weight, about 0.1% to about 4% by weight, about 0.1% to about 3% by weight, about 0.1% to about 2% by weight, about 0.1% to about 1% by weight, about 0.1% to about 0.9% by weight, about 0.1% to about 0.8% by weight, about 0.1% to about 0.7% by weight, about 0.1% to about 0.6% by weight, about 0.1% to about 0.5% by weight, about 0.1% to about 0.4% by weight, about 0.1% to about 0.3% by weight, or about 0.1% to about 0.2% by weight bound CO. Without wishing to be bound by theory, the present inventor theorizes that the presence of the π-acid ligand (such as, e.g., CO) may stabilize the structure of the hydrogen storage material (metal hydride, hydrogenated precipitate) due to the propensity of CO to form bridges between metal centres. For example, in one embodiment, the π-acid ligand (such as, e.g., CO) is terminally bound to the metal center (M). In another embodiment, the π-acid ligand (such as, e.g., CO) bridges between two metal (M) centers in a ketonic fashion (e.g., (M-(CO)-M). In another embodiment, the π-acid ligand (such as, e.g., CO) bridges two metal (M) centers in a multidentate fashion (e.g., M-C—O-M). In another embodiment, the π-acid ligand (such as, e.g., CO) bridges three metal (M) centers. The bound π-acid ligand (such as CO) may add structural stability through cycling and also mechanical stability to the microporous structure to vibrations, because of strong M/π-acid ligand bridging interactions.

In one embodiment, any of the hydrogen storage materials described herein (such as metal hydrides and hydrogenated precipitates) contain a π-acid ligand added in an amount ranging from about 0.1 to about 5 mol %, such as about 1 to about 5 mol %, about 1 to about 4 mol %, about 1 to about 3 mol %, or about 1 to about 2 mol %, relative to the metal (M) center, such as Mn.

In one embodiment, any of the hydrogen storage materials described herein (such as metal hydrides and hydrogenated precipitates) contain a π-acid ligand present. In one embodiment, any of the hydrogen storage materials (metal hydrides, hydrogenated precipitates) described herein contain a π-acid ligand present as a residue of one or more of the reactants.

### Hydrogen Storage

In another embodiment, the present invention relates to a method of storing hydrogen comprising providing a hydrogenated precipitate according to any of the embodiments described herein (e.g., a hydrogenated precipitate prepared according to any of the processes described herein), adding hydrogen to the hydrogenated precipitate, and allowing the hydrogen to coordinate to the hydrogenated precipitate. The storing of hydrogen may be carried out in a storage system.

One embodiment of a storage system suitable for hydrogen storage is a pressure vessel. For example, the pressure vessel may hold the metal hydride of the present invention at a temperature of up to 200° C., e.g., from about −100 to about 150° C., from about −50 to about 0° C., from about −25 to about 0° C., from about 0 to about 150° C., from about 0 to about 50° C., from about 10 to about 30° C. or from about 20 to about 25° C. In one embodiment, the storage system is substantially free of oxygen.

Hydrogen may be added to the storage system (e.g., a pressure vessel) and stored using the hydrogenated precipitates of the present invention. In one embodiment, no heating is required when adding hydrogen to the pressure vessel for storage.

The amount of hydrogen that can be stored by the hydrogenated precipitates of the present invention is proportional to the pressure in the storage system. For example, at higher pressures, more hydrogen can be stored by the metal hydrides of the present invention. The pressure in the storage system may be increased by adding hydrogen to the storage system. Without wishing to be bound by any particular theory, the inventor theorizes that as the pressure is increased, the number of Kubas interactions per metal centre may increase. As noted above, however, this process will appear continuous in the bulk state, resulting in the formation of a bulk material containing hydrogenated precipitates having a mixture of coordinated hydrogen molecules, and, therefore, an overall non-integer stoichiometry of manganese to hydrogen. Furthermore it may be possible (e.g., via a free radical and/or bimolecular process) to form molecular species of the formula MH₃, MH₅, MH₇, MH₉ and MH, etc.

In further embodiments, any of the hydrogenated precipitates described herein optionally contain one or more additional metals (e.g., a metal other than titanium, vanadium, chromium, manganese, iron, cobalt, nickel and copper). For example, the hydrogenated precipitate may contain one or more additional metals selected from sodium, potassium, aluminum, beryllium, boron, calcium, lithium, magnesium and combinations thereof. In an alternate embodiment, the hydrogenated precipitate may contain one or more additional metals (e.g., a metal other than titanium, vanadium, chromium, manganese, iron, cobalt, nickel and copper) wherein the one or more additional metals is a period 4, 5, 6, 7, 8, 9, 10, 11 and/or 12 transition metal, or a lanthanide, that forms a hydride upon treatment with hydrogen. For example, the hydrogenated precipitate may contain one or more additional metals selected from zirconium, niobium, molybdenum, technetium, ruthenium, rhodium, palladium, silver, and combinations thereof. In one embodiment, any of the hydrogenated precipitates described herein may optionally contain one or more additional period 4, period 5 or period 6 transition metals. In another embodiment, the hydrogenated precipitates may contain one or more additional metals selected from iron, zirconium, niobium, molybdenum, technetium, ruthenium, rhodium, palladium, silver, cadmium, hafnium, tantalum, tungsten, rhenium, osmium, iridium, platinum, gold, mercury, and combinations thereof. The one or more additional metals may be present in an amount of about 50 wt. % or less, about 40 wt. % or less, about 30 wt. % or less, about 25 wt. % or less, about 20 wt % or less, about 10 wt % or less, about 5 wt % or less, about 1 wt % or less, about 0.75 wt % or less, about 0.5 wt % or less, about 0.25 wt % or less, about 0.1 wt % or less, about 0.05 wt % or less or about 0.01 wt % or less. In one embodiment, the hydrogenated precipitates described herein contain no additional metal (e.g., no metal other than manganese).

The hydrogen pressure in the system may be increased using a compressor, such as a gas compressor, which pumps hydrogen into the system. Preferably, the hydrogen pressure in the system is increased to about 30 atm or more. For example, the hydrogen pressure in the system may be increased to from about 30 atm to about 500 atm, from about 50 atm to about 200 atm, or from about 75 atm to about 100 atm.

The system preferably has a temperature of (or operates at) up to 200° C., such as about −200° C. to 150° C. (e.g., about −100° C. to 150° C.), about −200° C. to 100° C., about 0° C. to 50° C., about 10° C. to 30° C., or about 20° C. to 25° C. In one embodiment, the system has a temperature (or operates at) about 25° C. to about 50° C. The system is preferably free of oxygen to prevent the oxidation of metal in the system. In one embodiment, the method of storing and releasing hydrogen in a system of the present invention may be carried out without adding heat to and/or cooling the system. In another embodiment, the method of storing and releasing hydrogen in a system of the present invention may be carried out by adding heat to and/or cooling the system.

In a further embodiment, the hydrogen is released from the storage system. For example, this may be accomplished by reducing the pressure of hydrogen in the system. In one embodiment, no heating is required in order to release the hydrogen from the metal hydride. For example, a valve in the storage system may be opened to allow hydrogen gas to escape from the system, thus decreasing the pressure in the storage system. In one embodiment, about 100% of the stored hydrogen is released. In additional embodiments, greater than about 50%, greater than about 55%, greater than about 60%, greater than about 70%, greater than about 75%, greater than about 80%, greater than about 90%, greater than about 95%, greater than about 97.5%, greater than about 99% or greater than about 99.5% of the hydrogen is released. The step of releasing the hydrogen pressure in the system may be carried out by allowing hydrogen gas to escape from the system, thus decreasing the hydrogen pressure. For instance, the step of releasing the hydrogen pressure may decrease the hydrogen pressure in the system to 100 atm or less (such as to 50 atm or less, 30 atm or less, or 20 atm or less). In another embodiment, the hydrogen is released from the storage system by increasing the temperature of the system.

Hydrogen may be added or released from the system at any point throughout the entire pressure gradient of the system without any adverse effects to the storage capacity of the system. In certain embodiments, hydrogen may be added or released from the system any number of times without any adverse effect to the storage capacity of the system. For example, the system can be filled with hydrogen and emptied of hydrogen at least 100, such as at least 200, at least 500, at least 1000 or at least 1500 times without a significant decrease in the storage capacity of the system.

In one embodiment, the storage system (e.g. pressure vessel) is a fuel tank in a vehicle, such as a truck or automobile.

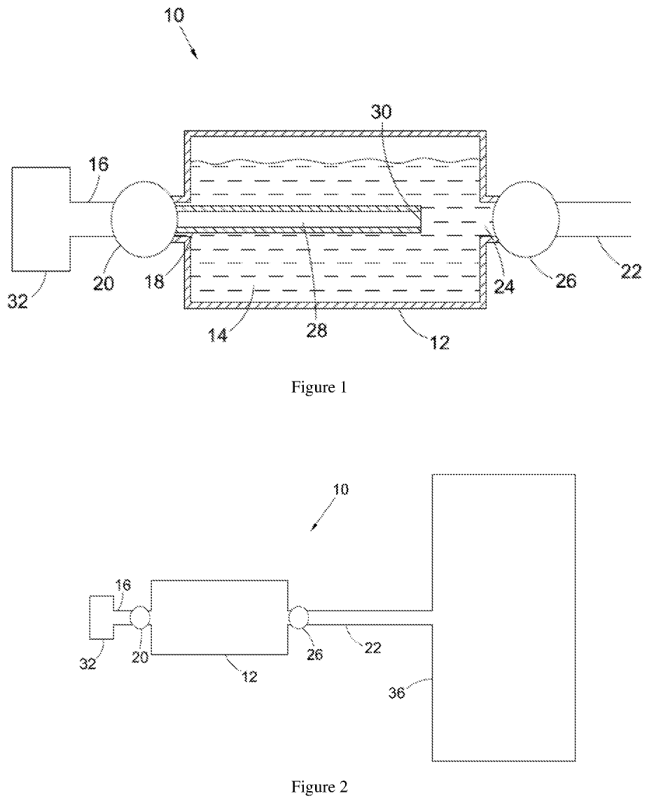

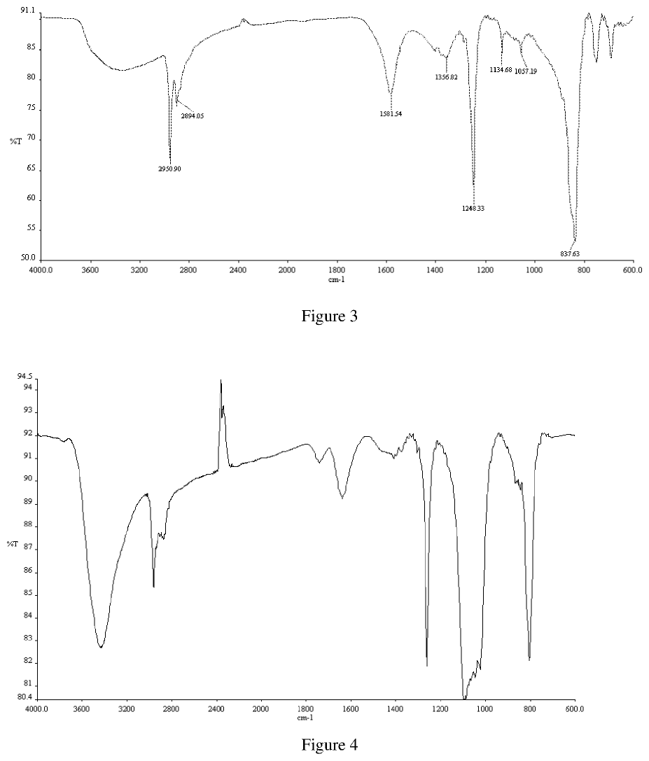

FIG. 1 depicts an embodiment of a storage system useful in the present invention. FIG. 2 depicts an embodiment of the storage system attached to a hydrogen fuel cell. The system 10 comprises a tank body 12 which is made of a material that is impermeable to hydrogen gas, thus preventing undesired leaking of the hydrogen gas out of the tank body 12. For example, the tank body 12 is made of metal, such as, e.g., steel or aluminum. Alternatively, the tank body 12 is made of a composite material, such as a composite of fibreglass and aramid. In another embodiment, the tank body 12 is made of a carbon fibre with a liner. The liner may be a polymer liner, such as a thermoplastic liner or a metal liner, such as a steel liner or an aluminum liner. In one embodiment the tank is an aluminum medical oxygen tank (e.g., an M-150 Al tank. See, e.g., http://nashvilleemsshop.com/Oxygen-Cylinder-M150_p_787.html).

The hydrogenated precipitate 14 is present inside the tank body 12. In FIG. 1, the hydrogenated precipitates 14 is in a gel form. The hydrogenated precipitates 14 may partially fill or totally fill the tank body 12. In certain embodiments, the hydrogenated precipitates may be present as a coating on a support or in pellet form, depending upon the requirements for pressure drops in the tank body. In additional embodiments, the hydrogenated precipitates may be present in admixture with other compounds (such as a binder) which enhance the structural integrity and other properties of the coating or the pellet.

A first passage 16 leads to a first opening 18 in the wall of the tank body 12. A first valve 20 controls the flow of hydrogen gas through the first opening 18.

A second passage 22 extends from a second opening 24 in the wall of the tank body 12. A second valve 26 controls the flow of hydrogen gas through the second opening 24.

The first valve 20 and the second valve 26 can be any type of valve that controls the flow of hydrogen gas through the first opening 18 and the second opening 24, respectively. For example, the first valve 20 and the second valve 26 can be ball valves or gate valves.

In one embodiment, hydrogen is added to the system 10 as follows. A gas compressor 32 pumps hydrogen gas into the first passage 16. The first valve 20 is opened to allow the hydrogen gas to flow through the first opening 18 and into the tank body 12.

A passage tube 28 is in gaseous communication with the first opening 18 and extends into the interior of the tank body 12. The passage tube 28 facilitates the distribution of the hydrogen gas to the hydrogenated precipitate 14. In one embodiment, the passage tube 28 is made of a material that is permeable to the hydrogen gas. This allows the hydrogen gas to pass through the wall of the passage tube 28 and into contact with the hydrogenated precipitate 14. The passage tube is also preferably made of a material that is impermeable to the metal hydride 14, thus preventing the hydrogenated precipitate 14 from entering into the interior of the passage tube 28. The passage tube 28 preferably opens into the interior of the tank body 12. The opening of the passage tube 28 is preferably covered with a filter 30 which prevents the hydrogenated precipitate 14 from entering into the interior of the passage tube 28.

When the compressor 32 pumps hydrogen gas into the tank body 12, there is an increase of the hydrogen pressure inside the tank body 12. When the hydrogen pressure inside the tank body is increased, the hydrogenated precipitate 14 is able to coordinate with a greater amount of hydrogen. Preferably, the increase in pressure causes an increase in the number of Kubas interactions per metal centre in the metal hydride 14. After the desired amount of hydrogen has been added to the system, the valve 20 is closed.

When desired, hydrogen may be released from the system 10 as follows. The second valve 26 is opened, which allows hydrogen gas to flow out of the tank body 12 through the second opening 24. When hydrogen gas flows out of the tank body through the second opening 24, there is a decrease in pressure inside the tank body 12. When the pressure is decreased inside the tank body 12, the hydrogenated precipitate 14 releases hydrogen. For example, the decrease in pressure may cause a decrease in the number of Kubas interactions per metal centre of the hydrogenated precipitate 14.

Hydrogen that is released by the hydrogenated precipitate 14 can flow out of the tank body 12 through the second opening 24. As shown in FIG. 2, the hydrogen can flow through the second passage 22 to a fuel cell 36. The fuel cell 36 preferably uses hydrogen as a fuel and oxygen as an oxidant to produce electricity. Typically, a filter is present at the second opening 24 in order to prevent loss of particulates downstream.

In an alternative embodiment, the storage system of the present invention comprises a storage tank with a single opening. In this embodiment, hydrogen flows both into and out of the storage tank through the single opening. A valve is used to control the flow of hydrogen through the opening. Since the enthalpies of H₂ binding are moderate to thermodynamically neutral and binding may be controlled by pressure, the tank may not need an exotic heat management system for most applications, unlike many prior hydrogen storage systems.

In one embodiment, the system is portable. As such, the system can be transported to a filling station to be filled with hydrogen. After being filled with hydrogen, the system can then be transported to a site where the hydrogen energy is to be used. Applications for this system include, but are not limited to, vehicles, airplanes, homes, buildings, and barbeques.

### EXAMPLES

The present invention will now be further described by way of the following non-limiting examples. In applying the disclosure of these examples, it should be kept clearly in mind that the examples are merely illustrative of the present invention and should not be construed as limiting the scope of the invention in any way as many variations and equivalents that are encompassed by the present invention will become apparent to those skilled in the art upon reading the present disclosure.

### Example 1

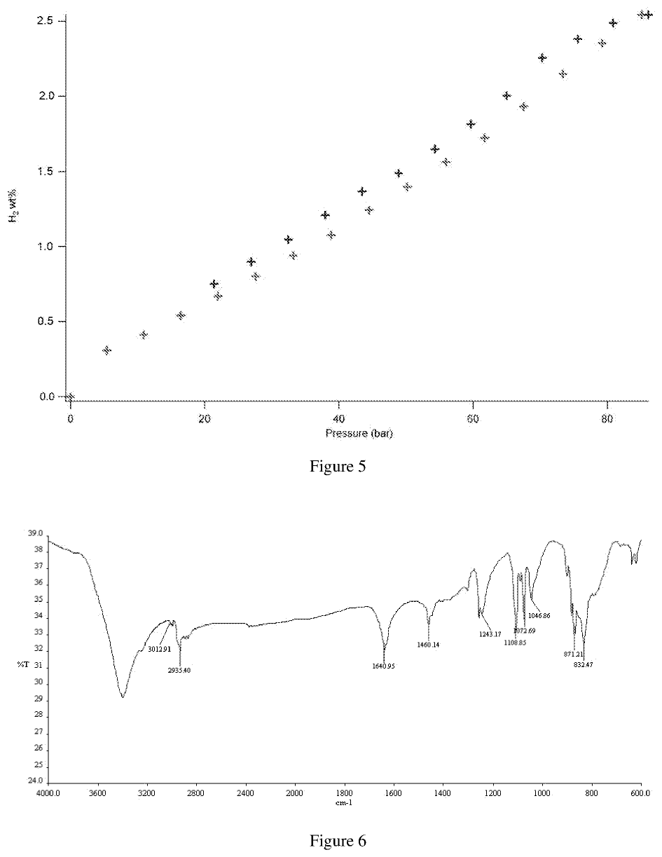

2.0 g of analytically pure bis (trimethylsilylmethyl) manganese (7.03 mmol) (see FIG. 3) was placed in a pressure vessel under an atmosphere of argon (Ar) with 100 mL of dry deoxygenated tetramethylsilane and charged with 2.0 mL of CO (0.09 mmol) by syringe. The sealed mixture was heated with stirring to 110° C. for 48 hours and subsequently the solvent was removed in vacuo (10⁻³ torr). The vessel was then charged with 10% H₂ in Kr to 80 bar and then heated to 80° C. for 4 hours followed by 5 minutes vacuum (10⁻³ torr) at 80° C. After cooling to room temperature, the pressure was released and the dark grey material collected. Yield=0.936 g. The Infra Red spectrum (FIG. 4) shows intense C—H stretches from 2800-3000 cm⁻¹ and two bridging CO stretches at 1730 cm⁻¹ 1640 cm⁻¹. Hydrogen adsorption/desorption measurements (FIG. 5; bottom trace (red)=adsorption, top trace (blue)=desorption) showed 2.5 wt % excess adsorption at 80 bar and 298 K.

### Example 2

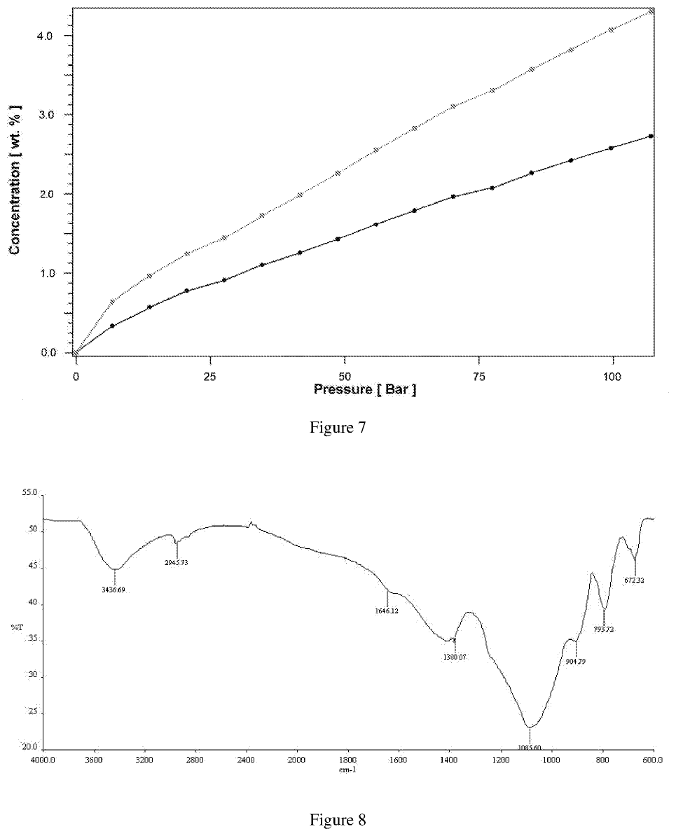

2.0 g of analytically pure bis (trimethylsilylmethyl) manganese (7.03 mmol) (see FIG. 3) was placed in a Schlenk tube with 0.040 g of Mn₂(CO)₁₀ (10 μmol) and 50 mL of dry deoxygenated 1,3,5 mesitylene was then added under an atmosphere of Ar. The mixture was heated with stirring to 130° C. for 24 hours and the solvent then boiled off in vacuo. The resulting solid was then placed in a Setaram hydrogen storage PCT vessel and subject to 4 hours H₂ (80 bar, 80° C.) followed by 5 minutes vacuum (10⁻³ torr) at 80° C. Yield=0.823 g. The Infra Red spectrum (FIG. 6) shows C—H stretches from 2800-3000 cm⁻¹ and one bridging CO stretch at 1640 cm⁻¹. Hydrogen adsorption measurements (FIG. 7) of an 80 mg sample show 2.6 wt % excess adsorption at 105 bar and 298 K (bottom trace), which was adjusted to 4.4 wt % adsorption (top trace) after taking into account weight loss from 80 mg to 51 mg during measurement.

### Example 3

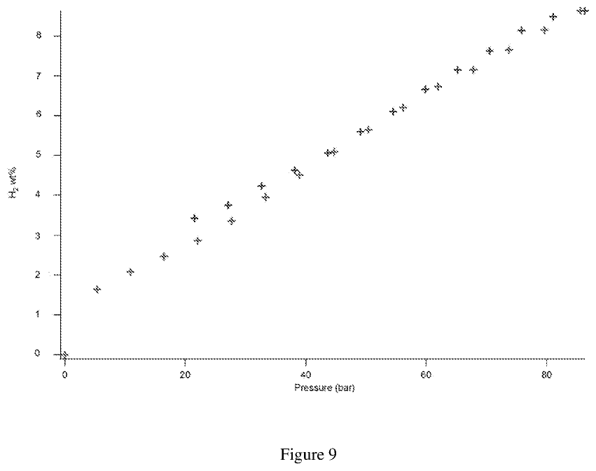

2.0 g of analytically pure bis (trimethylsilylmethyl) manganese (7.03 mmol) (see FIG. 3) was placed in a pressure vessel under an atmosphere of Ar and charged with 2.0 mL of CO (0.09 mmol). The vessel was then pressurized with methane to 80 bar and heated to 110° C. for 48 hours. The pressure was then released and the vessel was then charged with 10% H₂ in CH₄ to 80 bar and then heated to 80° C. for 4 hours followed by 5 minutes vacuum (10⁻³ torr) at 80° C. This was repeated a total of 5 times. The black solid (0.480 g) was collected. The Infra Red spectrum (FIG. 8) shows C—H stretches from 2800-3000 cm⁻¹ and one bridging CO stretch at 1646 cm⁻¹. Hydrogen adsorption/desorption measurements (FIG. 9, bottom trace (red)=adsorption, top trace (blue)=desorption) shows 8.4 wt % excess adsorption at 85 bar and 298 K. This result remained unchanged after heating 4 hours at 180° C. under vacuum (10⁻³ torr), or 4 hours in a Schlenk tube immersed at room temperature in an ultrasonic bath.

### Example 4

50 g (162 mmol) of MnI₂ (see Chem. Rev., 109, 1435, 2009) in 1000 mL of diethyl ether is treated with 21.4 g (162 mmol) of dilithio 1,3,5 mesitylene (prepared according to the method of Meyer, Tetrahedron, 32, 51-56, 1976) under argon in 250 mL diethyl ether by drop-wise addition at −78° C. The solution is allowed to warm to room temperature and stirred overnight. The solvent is then removed in vacuo and the solid extracted into toluene and filtered to remove LiI. The toluene is then removed in vacuo to afford the polymeric mesityl Mn species, which is characterized by Infra-Red spectroscopy and elemental analysis. The product is then hydrogenated in the solid state or in a supercritical solvent (e.g., supercritical Xe, supercritical Kr, supercritical methane, supercritical CO₂, or any combination thereof) to afford the hydrogen storage material.

The polymeric mesityl Mn species may also be prepared by heating bis(trimethylsilylmethyl)manganese in 1,3,5-mesitylene. CH-activation of the benzylic positions with elimination of tetramethylsilane leads to metathesis of the alkyl groups by Le Chatellier's Principle, as evidenced by the presence of C—C aromatic stretches in the Infra Red spectrum of the resulting product.

### Example 5

50 g of bis(trimethylsilylmethyl) manganese is placed in a high-pressure reactor equipped with a stirrer. The reaction vessel is then pressurized to 50 bar with high purity Xe (N5.0=99.999%) and heated to 100° C. The vessel is then further pressurized to 100 bar and the supercritical solution stirred for 24 hours. Cooling the vessel and depressurization affords a dark grey solid, which shows substantial hydrocarbon remaining by Infra Red spectroscopy. The product is then hydrogenated in the solid state or in a supercritical solvent (e.g., supercritical Xe, supercritical Kr, supercritical methane, supercritical CO₂, or any combination thereof) to afford the hydrogen storage material.

Optionally, the process described above is performed in one step using a supercritical Xe/H₂ or supercritical Kr/H₂ mixture. The sequence of steps, reaction temperatures, relative proportions of gas mixtures and pressures are adjusted to tune the final density, porosity, hydrogen storage properties, and bulk form (e.g., powder, foam, puck, monolith) of the final hydrogen storage material.

### Example 6

NaMn(CO)₅ (50.0 g, 229.5 mmol) (prepared by Na reduction of Mn₂(CO)₁₀ in THF) is added dropwise in 500 mL THF at 25° C. to 34.6 g (229.5 mmol) of (CH₃)₃SiCH₂COCl in 1000 mL THF (see Organometallics, 13, 5013-5020, 1994). (CO)₅Mn(COR) is in equilibrium under CO with (CO)₅MnR, which can also be made directly from (CO)₅MnNa and R—SO₃CF₃. The solution is then filtered to remove NaCl and the THF is removed in vacuo. 1,3,5-mesitylene (500 mL) is then added and the solution heated by slowly raising the temperature from 100-150° C. under a flow of Ar until a black solid begins to form. The solution is heated overnight at 100-150° C. under Ar and cooled to room temperature. The dark grey solid is collected by filtration and dried in vacuo to afford a black solid, which shows substantial hydrocarbon remaining by Infra Red spectroscopy. The product is then hydrogenated in the solid state or in a supercritical solvent (e.g., supercritical Xe, supercritical Kr, supercritical CO₂, or any combination thereof) to afford the hydrogen storage material.

### Example 7

A mixture of 50 g of bis(trimethylsilylmethyl) manganese and 200 mg Mn₂(CO)₁₀ is placed in a high-pressure reactor equipped with a stirrer. The reaction vessel is then pressurized to 50 bar with high purity CH₄ (N5.0=99.999%) and heated to 100° C. The vessel is then further pressurized to 100 bar and the supercritical solution stirred for 24 hours. Cooling the vessel and depressurization affords a dark grey solid, which shows a CO stretch and substantial hydrocarbon remaining by Infra Red spectroscopy. This species is then hydrogenated in pure H₂ or H₂ dissolved in supercritical CH₄ to yield the final hydrogen storage material.

### Example 8

50 g of bis(trimethylsilylmethyl) manganese is placed in a high-pressure reactor equipped with a stirrer. The reaction vessel is then pressurized to 50 bar with high purity CH₄ (N5.0=99.999%) and heated to 100° C. The vessel is then further pressurized to 100 bar and the supercritical solution stirred for 24 hours. Cooling the vessel and depressurization affords a dark grey solid, which shows substantial hydrocarbon remaining by Infra Red spectroscopy. This species is then hydrogenated in pure H₂ (with 0.0025 mol CO added by syringe) or a supercritical methane/H₂ mixture (with 0.025 mol CO added by syringe) to yield the final hydrogen storage material, which shows CO incorporation by IR.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

Patents, patent applications, publications, product descriptions, and protocols are cited throughout this application, the disclosures of which are incorporated herein by reference in their entireties for all purposes.

1.-166. (canceled)

167. A process for preparing a hydrogen storage material precursor comprising precipitating a manganese compound having one or more substituted or unsubstituted alkyl groups, substituted or unsubstituted aryl groups, or a combination thereof bound to the manganese via metal-carbon sigma bonds from (a) an inert solvent, (b) a solvent without a β-hydrogen, or a combination thereof,
wherein (i) the substituted or unsubstituted alkyl or substituted or unsubstituted aryl groups in the manganese compound do not have a β-hydrogen, and (ii) the precipitate when hydrogenated results in a material in which the manganese has an oxidation state of from 0.2 to 1.5 and is capable of absorbing H₂ via a Kubas interaction.

168. A process for preparing a hydrogen storage material comprising:
(i) precipitating a manganese compound having one or more substituted or unsubstituted alkyl groups, substituted or unsubstituted aryl groups, or a combination thereof from (a) an inert solvent, (b) a solvent without a β-hydrogen, or a combination thereof, and
(ii) hydrogenating the precipitate,
wherein the manganese in the hydrogenated precipitate has an oxidation state of from 0.2 to 1.5 and the hydrogen storage material is capable of absorbing H₂ via a Kubas interaction.

169. The process of claim 167, wherein the precipitation results in condensation of an initial manganese compound.

170. The process of claim 167, wherein the precipitate is prepared from a manganese compound that has two substituted or unsubstituted alkyl groups, and each substituted or unsubstituted alkyl group is linked to the manganese via a 2-electron 2-center single bond.

171. The process of claim 167, wherein the metal-carbon sigma bonds are not 3-center 2-electron bonds.

172. The process of claim 167, wherein the precipitate is prepared from a manganese compound that is (Me₃Si—CH₂)₂Mn.

173. The process of claim 167, wherein the solvent is an inert solvent (e.g., supercritical xenon, supercritical krypton, supercritical methane, supercritical CO₂, or any combination thereof).

174. The process of claim 167, wherein the solvent is selected from supercritical xenon, supercritical krypton, supercritical methane, supercritical CO₂, a tetralkylsilane (e.g., tetramethylsilane), adamantane, cubane, neopentane, xylene, trimethylbenzene (e.g., 1,3,5-trimethylbenzene), and any combination thereof.

175. The process of claim 167, wherein the solvent is 1,3,5-trimethylbenzene.

176. The process of claim 167, wherein the concentration of the manganese compound in the solvent is greater than about 3.1 g/100 mL.

177. The process of claim 167, wherein the precipitating step is performed in the absence of H₂.

178. The process of claim 167, wherein the precipitating step involves thermal precipitation, photochemical precipitation, or a combination thereof.

179. The process of claim 167, wherein the precipitating step comprises heating the manganese compound and isolating the precipitate.

180. The process of claim 167, wherein the precipitate weighs greater than about 40% of the original weight of the manganese compound.

181. The process of claim 167, wherein the precipitate contains greater than about 40% by weight of residue other than manganese.

182. The process of claim 167, wherein the hydrogenated material is capable of absorbing H₂ by Kubas interation and/or physisorption to a level of at least about 2 wt %, at least about 4 wt %, at least about 8 wt %, at least about 10 wt %, at least about 10.5 wt % or at least about 12 wt %.

183. The process of claim 167, wherein the hydrogenated material comprises MnHₓ, optionally further comprising residual hydrocarbon and/or solvent, where x is 0.2 to 1.5 and is capable of reversibly storing more than two H₂ molecules per Mn.

184. The process of claim 167, wherein the manganese in the hydrogenated material comprises Mn(I) and Mn(II).

185. The process of claim 167, wherein the precipitate is formed by condensation of the manganese compound.

186. The process of claim 167, wherein the hydrogenated material is a bulk solid.

187. The process of claim 167, wherein the hydrogenated material is stable at room temperature.

188. The process of claim 167, wherein the hydrogenated material further comprises one or more additional metals.

189. The process of claim 188, wherein the one or more additional metals are selected from niobium, molybdenum, technetium, ruthenium, rhodium, palladium, silver, iron, zirconium, zinc, gallium, cadmium, hafnium, tantalum, tungsten, rhenium, osmium, iridium, platinum, gold, mercury, and any combination thereof.

190. The process of claim 167, further comprising (i) subjecting the hydrogenated material to vacuuming, heating, or both, and optionally (ii) repeating one or more times (a) hydrogenation of the vacuumed and/or heated material and (b) subjecting the hydrogenated material to vacuuming, heating, or both.
